(19) United States
(12) Patent Application Publication
(10) Pub. No.: US 2026/0005328 A1
(43) Pub. Date: Jan. 1, 2026

(54) METHOD OF ENHANCING CYCLE LIFE OF THREE-DIMENSIONAL METAL ANODES

(71) Applicant: Kansas State University Research Foundation, Manhattan, KS (US)

(72) Inventors: Jun Li, Manhattan, KS (US); Sabari Rajendran, Manhattan, KS (US)

(21) Appl. No.: 19/252,290

(22) Filed: Jun. 27, 2025

Related U.S. Application Data
(60) Provisional application No. 63/665,538, filed on Jun. 28, 2024.

(51) Int. Cl. H01M 10/44; H01M 4/02; H01M 4/38; H01M 4/66; H01M 4/78

(52) U.S. Cl. CPC H01M 10/44; H01M 4/382; H01M 4/663; H01M 4/78; H01M 2004/027

(57) ABSTRACT

Methods of enhancing the cycle life of metal anodes, and particularly lithium anodes, of rechargeable batteries are provided. Decoupling the plating current density from the stripping current density has been shown to provide high stability and reversibility for plating and stripping cycles, especially when a 3-D conductive host, such as a vertically aligned carbon nanofiber array, is employed. In particular, a relatively high plating current density is employed to produce more uniform metal morphologies comprising smaller micro-columns or micro-spheres, and moderate to low stripping current densities are employed to more completely strip the metal thereby reducing dead metal deposits remaining on the anode.

### CROSS-REFERENCE TO RELATED APPLICATIONS

The present application claims the priority benefit of U.S. Provisional Patent Application Ser. No. 63/665,538, filed Jun. 28, 2024, entitled METHOD OF ENHANCING CYCLE LIFE OF THREE-DIMENSIONAL METAL ANODES, incorporated by reference in its entirety herein.

### STATEMENT REGARDING FEDERALLY SPONSORED RESEARCH OR DEVELOPMENT

This invention was made with government support under Contract Nos. CBET-2054754 and DMR-1707585 awarded by the National Science Foundation. The government has certain rights in the invention.

### BACKGROUND OF THE INVENTION

### Field of the Invention

A method for enhancing the cycling life of lithium metal anodes based on a three-dimensional conductive host has been developed. The method is based on a charge-discharge protocol that decouples the plating and stripping processes to control the morphology and electrochemical performance of electrodeposited metal as the metal anodes. The method has application in batteries based upon several types of metals as the anodes, including lithium, sodium, potassium, and zinc.

### Description of the Prior Art

High energy density batteries are essential for achieving the decarbonization goals in the transition to clean energies and for meeting future energy demands. Lithium metal is considered as the leading element of anode materials for next-generation high energy batteries owing to its highest theoretical charge storage capacity (3860 mAh/g) and the lowest redox potential (-3.04 V vs. the standard hydrogen electrode (SHE)). The lithium metal anode (LMA), when paired up with high Ni-NMC cathodes (>200 mAh/g) or high-capacity cathodes such as sulfur or oxygen, enables the potential development of batteries with energy densities greater than 500 Wh/kg, significantly surpassing the 350 Wh/kg limit of current lithium-ion batteries (LIBs). Among all possible configurations of rechargeable lithium metal batteries (LMBs), the anode-free LMBs offer the highest possible theoretical energy density as it does not involve excess lithium, which also lowers the manufacturing cost and improves the safety in operation.

Rechargeable batteries function by storing and releasing electrical energy in a reversible manner, utilizing chemicals. An LMA releases electrons while discharging/stripping by the oxidation of lithium metal into Li+ ions at the negative electrode (i.e., the anode). During the charging/plating process, Li+ ions in the electrolyte undergo reduction leading to the deposition of lithium metal on the negative current collector. The properties of electrodeposited lithium and the LMA performance have been found to depend strongly on the nature of current collector, electrolyte, operating conditions, and plating/stripping parameters. Identifying the Li morphology in 3-D conductive hosts that allows for reversible cycling, along with the corresponding operating parameters, is crucial for the development of high-performance LMAs.

### SUMMARY OF THE INVENTION

According to one embodiment of the present invention there is provided a method of operating a battery having an anode comprising a metal. The method comprises applying to the battery cell a charging electrical current having a first current density thereby reducing ions of the metal contained within an electrolyte at the anode and plating the anode with the metal. A discharging electrical current is withdrawn from the battery cell having a second current density thereby oxidizing and stripping the metal from the anode and dispersing the ions of the metal into the electrolyte. The first current density is different from, and preferably greater than the second current density.

According to another embodiment of the present invention there is provided a method of operating a battery having an anode comprising lithium. The method comprises applying to the battery cell a charging electrical current having a first current density thereby reducing lithium ions contained within an electrolyte at the anode and plating the anode with the lithium. A discharging electrical current having a second current density is withdrawn from the battery cell thereby oxidizing and stripping the lithium from the anode and dispersing the ions of the metal into the electrolyte. The first current density is greater than the second current density.

According to still another embodiment of the present invention there is provided a method of cycling a battery between states of charging and discharging. The battery comprises an electrolyte, a current collector comprising a three-dimensional nanostructured conductive material (such as a plurality of vertically-aligned carbon nanofibers (VACNFs), other forms of carbon, nickel, copper or steel) as a lithium-less anode, and a lithiated cathode (such as LiCoO₂, LiFePO₄, LiMnO₄, LiS₂, various lithium nickel manganese cobalt oxides, etc.). The method comprises applying to the VACNF current collector to the battery cell a charging electrical current having a first current density thereby reducing lithium ions contained within the electrolyte at the anode and plating the VACNFs with the lithium. A discharging electrical current having a second current density that is less than the first current density is withdrawn from the battery cell thereby oxidizing and stripping the lithium from the VACNFs and dispersing the lithium ions into the electrolyte.

### BRIEF DESCRIPTION OF THE DRAWINGS

FIG. 1A depicts a schematic illustration of the opposite trends of Sand's time t_{Sand} and

nucleation rate vₙ vs. the Li plating current density j;

FIG. 1B depicts a 30° perspective view FESEM image of the pristine VACNF/Cu electrode;

FIG. 1C depicts Li plating volage curves at current densities of 0.10 mA/cm², 0.50 mA/cm², 1.0 mA/cm², and 5.0 mA/cm² for a VACNF/Cu electrode;

FIG. 1D depicts Li plating volage curves at current densities of 0.10 mA/cm², 0.50 mA/cm², 1.0 mA/cm², and 5.0 mA/cm² for a planar Cu electrode;

FIG. 1E depicts the coulombic efficiency during plating/stripping cycling of VACNF/Cu and planar Cu electrodes with a Li plating capacity of 2.0 mAh/cm² at the symmetric plating/stripping current density of 0.1 mA/cm²;

FIG. 1F depicts the coulombic efficiency during plating/stripping cycling of VACNF/Cu

and planar Cu electrodes with a Li plating capacity of 2.0 mAh/cm² at the symmetric plating/stripping current density of 1.0 mA/cm²;

FIG. 1G depicts the coulombic efficiency during plating/stripping cycling of VACNF/Cu

and planar Cu electrodes with a Li plating capacity of 2.0 mAh/cm² at the symmetric plating/stripping current density of 5.0 mA/cm²;

FIG. 1H is a TEM image of pristine VACNF;

FIG. 1I is a schematic of the typical coin-cell assembly configuration used for the Examples;

FIG. 2A depicts (a) an optical image of a developed Prescale film showing the pressure distribution inside the coin cell configuration shown in FIG. 1I; the 30° perspective view FESEM images of a planar Cu electrode plated with 0.20 mAh/cm² Li at 0.10 mA/cm² which are imaged at center, shown in (b) & periphery, shown in (d) of the electrode; images (c) and (e) and zoomed in images of (b) and (d), respectively;

FIG. 2B is a developed Prescale film of different working pressure ranges illustrating the pressure distribution inside coin cells under different levels of compression;

FIG. 3A depicts a representative optical image of Cu plated with 0.75 mAh/cm² Li at 0.10 mA/cm²;

FIGS. 3B-Q depict FESEM images imaged at specified locations, with Figs. B-I comprising lithium plated with a compression percentage of 16%, and Figs. J-Q comprising lithium plated with a compression percentage of 38%, FIGS. 3J-Q are top view images;

FIG. 4 depict FESEM images of Li electrodeposited on planar Cu electrodes under varying current densities and varying plating capacities;

FIG. 5A depicts a top view FESEM image of planar Cu after electrodepositing of Li of 0.20 mAh/cm² capacities at a low current density of 0. 10 mA/cm²;

FIG. 5B is a magnified image of FIG. 5A;

FIG. 5C depicts a top view FESEM image of planar Cu after electrodepositing of Li of 0.75 mAh/cm² capacities at a low current density of 0. 10 mA/cm²;

FIG. 5D is a magnified image of FIG. 5C;

FIG. 5E depicts a top view FESEM image of planar Cu after electrodepositing of Li of 2.0 mAh/cm² capacities at a low current density of 0. 10 mA/cm²;

FIG. 6A depicts a FESEM image of electrodeposited Li on planar Cu at 0.1 mA/cm² for a capacity of 0.20 mAh/cm²;

FIG. 6B depicts a FESEM image of electrodeposited Li on planar Cu at 0.1 mA/cm² for a capacity of 2.0 mAh/cm²;

FIG. 7A depicts a top-view FESEM image of Cu plated with a 0.75 mAh/cm² capacity of Li at 0.10 mA/cm² imaged at periphery of the electrode;

FIG. 7B depicts a magnified top-view FESEM image of Cu plated with a 0.75 mAh/cm² capacity of Li at 0.10 mA/cm² imaged at periphery of the electrode;

FIG. 7C depicts a top-view FESEM image of Cu plated with a 2.0 mAh/cm² capacity of Li at 0.10 mA/cm² imaged at periphery of the electrode;

FIG. 7D depicts a magnified top-view FESEM image of Cu plated with a 2.0 mAh/cm² capacity of Li at 0.10 mA/cm² imaged at periphery of the electrode;

FIG. 8A, 8B, and 8C depict 30° perspective FESEM images of 0.75 mAh/cm² of Li plated on the planar Cu electrode at 0.10 mA/cm² and then stripped completely at 0.10 mA/cm²;

FIGS. 8D, 8E, and 8F depict 30° perspective FESEM images of 0.75 mAh/cm² of Li plated on the planar Cu electrode at 0.10 mA/cm² and then stripped completely at 1.0 mA/cm²;

FIG. 9A depicts a 30° perspective FESEM image of planar Cu plated with 0.75 mAh/cm² at 1.0 mA/cm², arrows indicate dendrite-like Li growth;

FIG. 9B depicts a 30° perspective FESEM image of planar Cu plated with 0.75 mAh/cm² at 1.0 mA/cm², arrows indicate dendrite-like Li growth;

FIG. 10A depicts a 30° perspective FESEM image of electrodeposited Li of 0.75 mAh/cm² capacity on planar Cu at 1.0 mA/cm² and then stripped completely at 1.0 mA/cm²;

FIG. 10B depicts a 30° perspective FESEM image of electrodeposited Li of 0.75 mAh/cm² capacity on planar Cu at 1.0 mA/cm² and then stripped completely at 1.0 mA/cm²;

FIG. 10C depicts a 30° perspective FESEM image of electrodeposited Li of 0.75 mAh/cm² capacity on planar Cu at 1.0 mA/cm² and then stripped completely at 1.0 mA/cm²;

FIGS. 11A, B, and C depict FESEM images of 0.75 mAh/cm² of Li plated on Cu at 5.0 mA/cm² and then stripped completely at 5.0 mA/cm²at a 30° perspective, where 11B and 11C are magnifications of the corresponding rectangles in 11A;

FIGS. 11D, E, and F depict FESEM images of 0.75 mAh/cm² of Li plated on Cu at 5.0 mA/cm² and then stripped completely at 1.0 mA/cm²at a 30° perspective, where 11E and 11F are magnifications of the corresponding rectangles in 11D;

FIG. 12 depicts 30° perspective view FESEM images of electrodeposited Li on VACNF/Cu at different current densities up to various plating capacities;

FIGS. 13A and 13B depict FESEM images of VACNF/Cu plated with 0.20 mAh/cm² Li at 0.10 mA/cm² at a 30° perspective;

FIG. 13C depicts a FESEM image of VACNF/Cu plated with 0.20 mAh/cm² Li at 1.0 mA/cm² at a 30° perspective;

FIG. 13D depicts a FESEM image of VACNF/Cu plated with 0.20 mAh/cm² Li at 5.0 mA/cm² at a 30° perspective;

FIGS. 14A and 14B depict top-view FESEM images of VACNF/Cu plated with 0.75 mA/cm² Li at 0.10 mA/cm² imaged at the center of the electrode where 14B is a magnified image of the rectangle area depicted in 14A;

FIGS. 14C and 14D depict top-view FESEM images of VACNF/Cu plated with 0.75 mA/cm² Li at 0.10 mA/cm² imaged at the periphery of the electrode where 14D is a magnified image of the rectangle area depicted in 14C;

FIG. 15 depicts 30° perspective FESEM images of electrodeposited Li on VACNF/Cu at the current density of 0.10 mA/cm² for a capacity of 0.75 mAh/cm² Li and then stripped completely at the current density of 0.10 mA/cm²;

FIG. 16 depicts the FIB-FESEM image of VACNF/Cu plated with 2.0 mAh/cm² Li at 1.0 mA/cm² at a 45° perspective;

FIG. 17 depicts 30° perspective FESEM images of electrodeposited Li on VACNF/Cu at the current density of 1.0 mA/cm² for a capacity of 0.75 mAh/cm² and then stripped completely at the current density of 1.0 mA/cm²,

FIG. 18 is a 30° perspective FESEM image of VACNF/Cu plated with 0.75 mAh/cm² Li at 0.5 mA/cm²;

FIGS. 19A and 19B depict 30° perspective FESEM images of electrodeposited Li on VACNF/Cu at a current density of 5.0 mA/cm² for a capacity of 0.75 mAh/cm²;

FIG. 20A depicts a 30° perspective FESEM image of electrodeposited Li on VACNF/Cu at a current density of 5.0 mA/cm² for a capacity of 2.0 mAh/cm² and then stripped completely at 1.0 mA/cm²;

FIG. 20B depicts a 30° perspective FESEM image of electrodeposited Li on VACNF/Cu at a current density of 5.0 mA/cm² for a capacity of 2.0 mAh/cm² and then stripped completely at 5.0 mA/cm²;

FIG. 21A depicts a Cryo-TEM image of Li deposited VACNF with 0.75 mAh/cm² Li at a 0.10 mA/cm² current density;

FIG. 21B depicts a Cryo-TEM image of Li deposited VACNF with 0.75 mAh/cm² Li at a 1.0 mA/cm² current density;

FIG. 21C depicts a Cryo-TEM image of Li deposited VACNF with 0.75 mAh/cm² Li at a 5.0 mA/cm² current density;

FIG. 22A depicts a Cryo-TEM image of VACNFs deposited with 0.75 mAh/cm² Li at a 0.10 mA/cm² current density, and then completely stripped;

FIG. 22B depicts a Cryo-TEM image of VACNFs deposited with 0.75 mAh/cm² Li at a 1.0 mA/cm² current density, and then completely stripped;

FIG. 23A shows a histogram of the size distribution of infiltrative Li grains electrodeposited to a capacity of 0.75 mAh/cm² on VACNF/Cu at a current density of 0.10 mA/cm *;

FIG. 23B shows a histogram of the size distribution of infiltrative Li grains electrodeposited to a capacity of 0.75 mAh/cm′ on VACNF/Cu at a current density of 0.50 mA/cm²;

FIG. 23C shows a histogram of the size distribution of infiltrative Li grains electrodeposited to a capacity of 0.75 mAh/cm² on VACNF/Cu at a current density of 1.0 mA/cm²;

FIG. 23D shows a histogram of the size distribution of infiltrative Li grains electrodeposited to a capacity of 0.75 mAh/cm² on VACNF/Cu at a current density of 5.0 mA/cm²;

FIG. 23E shows the relationship between current density (j) and Li nucleation overpotential (nn) for planar Cu and VACNF/Cu electrodes;

FIG. 23F shows the correlation between the size of electrodeposited Li (du) and the inverse of Li nucleation overpotential (1/ηₙ) on planar Cu and VACNF/Cu electrodes;

FIG. 24A shows a histogram for the size of electrodeposited Li for a capacity of 0.75 mAh/cm² on planar Cu at a current density of 0.10 mA/cm²;

FIG. 24B shows a histogram for the size of electrodeposited Li for a capacity of 0.75 mAh/cm² on planar Cu at a current density of 0.50 mA/cm²;

FIG. 24C shows a histogram for the size of electrodeposited Li for a capacity of 0.75 mAh/cm² on planar Cu at a current density of 1.0 mA/cm²;

FIG. 24D shows a histogram for the size of electrodeposited Li for a capacity of 0.75 mAh/cm² on planar Cu at a current density of 5.0 mA/cm²;

FIG. 25A illustrates a chart depicting the effect of the current density (j) on the size of Li grains (dui) on planar Cu and VACNF/Cu electrodes, where the graph illustrates the relationship between dui and j;

FIG. 25B illustrates a chart depicting the effect of the current density (j) on the size of Li grains (dui) on planar Cu and VACNF/Cu electrodes, where the graph illustrates the relationship between dui vs. log j;

FIG. 26A depicts a schematic illustration of the effect of the plating current density on the morphology of Li deposits on planar Cu and VACNF/Cu electrodes.

FIG. 26B depicts a graph illustrating the coulombic efficiency during plating/stripping cycling of 2.0 mAh/cm² Li plated on VACNF/Cu electrodes at different current densities but stripped at the fixed current density of 1.0 mA/cm², and the inset shows the average coulombic efficiency for cycles 2-11 at different plating current densities;

FIG. 27A depicts a graph illustrating the coulombic efficiency cycling performance of planar Cu at different plating current densities with the stripping current density at 1.0 mA/cm²;

FIG. 27B depicts a graph illustrating the coulombic efficiency cycling performance of planar Cu at different plating current densities with the stripping current density at 5.0 mA/cm²;

FIG. 28 is a chart depicting average coulombic efficiency for cycles 2-11 with different plating current densities and with the same stripping current density of 1.0 mA/cm² for planar Cu and VACNF/Cu electrodes; and

FIG. 29 is a chart depicting average coulombic efficiency for planar Cu and VACNF/Cu electrodes under different plating and stripping current densities.

### DETAILED DESCRIPTION OF THE PREFERRED EMBODIMENT

Reversible lithium metal anodes (LMAs) are an essential element for rechargeable lithium metal batteries. Three-dimensional (3-D) conductive hosts have been extensively explored as an effective approach to suppressing dendrite formation and enabling reversible Li plating/stripping. However, the microscopic morphologies of Li plating and their correlation with the cell performance are not clear. Embodiments of the present invention utilize the vertically aligned carbon nanofiber (VACNF) array as a model 3-D conductive carbon host which has a well-defined vertical low-tortuosity structure allowing observation of the intrinsic Li morphologies infiltrated into the 3-D host. The VACNF array indeed provides much higher stability and reversibility for Li plating/stripping due to its high surface area and lithiophilic properties. Information regarding the VACNF array and synthesis thereof may be found in Rajendran, S.; Sekar, A.; Li, J., Mechanistic Understanding of Li Metal Anode Processes in a Model 3D Conductive Host Based on Vertically Aligned Carbon Nanofibers. Carbon 2023, 212, 118174. DOI: 10.1016/j.carbon.2023.118174; Chen, Y.; Elangovan, A.; Zeng, D.; Zhang, Y.; Ke, H.; Li, J.; Sun, Y.; Cheng, H., Vertically Aligned Carbon Nanofibers on Cu Foil as a 3D Current Collector for Reversible Li Plating/Stripping toward High-performance Li—S Batteries. Advanced Functional Materials 2020, 30 (4), 1906444. DOI: 10.1002/adfm.201906444; and U.S. Pat. Nos. 9,412,998, 9,362,549, 10,205,166, and 11,075,378, all of which are incorporated by reference herein in their entireties.

Among the influential parameters, the applied current density, j, has been found to be a key variable since it regulates the rate of reduction of Li⁺ ions to Li metal. Studies on planar copper current collectors have demonstrated that the microscopic morphology strongly depends on the plating current density, j. In general, the Li nuclei density Nₙ increases with the magnitude of j following the classical nucleation and growth theory. The plated Li tends to form sparsely distributed large irregular Li nuclei when it is deposited at low j but to form densely populated and more uniform Li particles of smaller sizes at high j. On the other hand, macroscopic electrochemical studies have indicated that the electrodeposited Li is more reversible and stable at low j, possibly due to the lower concentration gradient and more homogeneous electric field distribution. The formation of dendritic Li structures is accelerated when the Li⁺ ion concentration depletes at the anode surface. The average time that it takes for the dendrites to start growing is represented by the Sand's time t_{Sand} which increases as the j is reduced. The microscopic and macroscopic studies seem to point the opposite directions in how to reduce Li dendrite growth by regulating the plating current density j. Since dendrite growth during charging or lithium electrodeposition is one of the critical issues limiting the development of LMAs, it is important to unravel the hidden connections between the seemingly controversial macroscopic and microscopic observations and develop new mitigating strategies.

Several approaches, such as modification of the current collector, electrolyte, and operating parameters, have been successfully developed to mitigate dendrite growth and enhance the coulombic efficiency (CE) and cycle life. The use of high-surface-area three-dimensional (3-D) hosts was found to be effective in delaying the dendrite formation, which was attributed to the reduced local current density j and the homogenized electric field compared to those on the planar electrodes. The lower j apparently increased the Sand's time t_{Sand} and delayed the onset of dendrite formation. However, this will make the microscopic morphology of the plated Li more heterogeneous, as predicted by the nucleation and growth theory validated on the planar electrodes. It is expected that the 3-D hosts will induce lower nucleation density (i.e., lower surface coverage) and larger grain sizes due to the lower local current density. But the microscopic morphology of Li plating onto the 3-D hosts and how it changes vs. the plating current density j have not been well studied so far. This is challenging since most studies on 3-D host materials employed random porous structures, making it difficult to reveal the microscopic structure of the Li infiltrated into the hosts. In fact, even on planar electrodes, two different morphologies of Li have been reported under the similar conditions of electrodeposition, i.e., at j≤0.1 mA/cm² in the standard ether electrolyte (1.0 M lithium bis(trifluoromethanesulfonyl)imide (LiTFSI) in 1,3-dioxolane (DOL) and 1,2-dimethoxyethane (DME) (v/v 1:1) with 1 wt % LiNO₃ additive). Island-like Li growth and fibrous Li growth on planar copper electrodes have been observed. The island-like Li growth with a low surface area and low porosity is a desired morphology as it can be stripped more efficiently leaving less dead lithium and SEI. In contrast, fibrous Li is more prone to form dead Li due to the higher probability for breaking off the Li fibers during the non-homogeneous stripping. In addition, the higher aspect ratio and larger exposed surface area of fibrous Li would increase the electrolyte consumption due to the repeated SEI formation.

It has been discovered that Li plating on both VACNF array and planar Cu electrodes follows the classical nucleation and growth model. Though the low plating current density (≤ 0.10 mA/cm²) provides better cycling stability consistent with the Sand's equation, it forms sparse irregular grains stacked with dendrite-like long Li fibers. In contrast, the moderate to high plating current densities (1.0-5.0 mA/cm²) produce more uniform Li morphologies consisting of smaller micro-columns or micro-spheres. By decoupling the plating and stripping current densities, it has been found that the more uniform micro-columnar Li infiltrated in the VACNF array obtained at the moderate plating current density (˜1.0 mA/cm²) indeed exhibits the highest cycling performance.

Accordingly, in one or more embodiments, a charge-discharge protocol is provided that comprises decoupled plating and stripping steps with different current densities to control the electrodeposited Li structures. In contrast to the conventional methods that prefer to use a low current density with the same value for both Li plating and stripping processes, embodiments of the present invention use different plating and stripping current densities, and preferably a relatively higher plating current density and a moderate or low stripping current density, which gives the optimal cycling performance in correlation to the more uniform micro-columnar Li metal morphologies. This method also enables the correlation of the Li morphologies created by a wide range of electrodeposition rates with their cycling performance. These are supported by the observation of the Li-plating following the classical nucleation/growth theory in the 3-D host based on vertically aligned carbon nanofiber arrays. It can be extended to general 3-D conductive hosts as metal anodes.

Besides lithium anodes, other types of metal anodes can be used, including sodium, potassium, and zinc. Similar methodologies for decoupling the plating and stripping current densities as described herein for three-dimensional current collectors can be followed. Exemplary electrolytes that may be used with such alternate metal anodes include, for zinc batteries, (1) 2.0 M ZnSO₄, (2) 2.0 M Zn (CIO₄)₂, or (3) 3 M zinc trifluoromethanesulfonate (ZnCF₃SO₃); for Na batteries, (1) 1.0 M NaPF₆ in mixed ethylene carbonate/propylene carbonate solvent, or (2) 1.0 M sodium perchlorate (NaClO₄) in propylene carbonate solvent; for K batteries, 1.0 M potassium bis(fluorosulfonyl) amide (KFSI). For Li batteries, an exemplary electrolyte may be 1.0 M lithium bis(trifluoromethanesulfonyl)imide (LiTFSI) in 1,3-dioxolane (DOL) and 1,2-dimethoxyethane (DME) (v/v 1:1) with 1 wt % LiNO₃ additive.

In some embodiments, the current collector is a three-dimensional current collector. In some embodiments, the current collector does not comprise lithium. The three-dimensional current collector can comprise a nanostructure material, such as a plurality of vertically aligned carbon nanofibers (VACNF). The three-dimensional current collector can comprise a nonstructured porous conductive material comprised of carbon, nickel, copper, and/or steel.

When applying a charging electrical current to the cell, i.e., a current flowing from the anode to the cathode in the external circuit while positive metal ions flowing from the cathode to the anode inside the cell, having a first current density, the first current density has a value that is greater than about 0.10 mA/cm², greater than about 0.50 mA/cm², or greater than about 0.75 mA/cm², and/or less than about 10 mA/cm². less than about 7.5 mA/cm², or less than about 5 mA/cm². Applying a charging electrical current to the anode results in plating the anode with the metal. The plating capacity has a value of at least 0.2 mAh/cm², from about 0.2 mAh/cm² to about 10 mAh/cm², from about 0.75 mAh/cm² to about 7.5 mAh/cm², or from about 1.0 mAh/cm² to about 5.0 mAh/cm². After applying a charging electrical current to the anode, a substantially uniform layer of the metal is formed on the anode. Advantageously, the substantially uniform layer of the metal on the anode comprises micro-columnar deposits of the metal. In some embodiments, the substantially uniform layer on the anode comprises lithium, preferably micro-columnar deposits of lithium infiltrated in a porous structure of the three-dimensional current collector.

When withdrawing a discharging electrical current from the cell, i.e. a current flowing from the cathode to the anode in the external circuit while metal ions flowing from the anode to the cathode inside the cell, having a second current density in the opposite direction of the first current density, the second current density has a value that is at least 0.10 mA/cm², at least 0.50 mA/cm², or at least 0.75 mA/cm², and/or no more than 5.0 mA/cm². no more than 2.5 mA/cm², or no more than 1.0 mA/cm². The first current density is different than the second current density, and preferably the first current density is greater than the second current density. Advantageously, the anode exhibits an average Coulombic Efficiency (CE) of at least 80%, at least 90%, at least 95%, at least 99%, or at least 99.9% after 100 cycles of the applying and withdrawing steps.

In addition to being in the form of hard-case coin cells, in one embodiment, the battery cells can be pouch cells comprising a stack of multiple anode sheets and cathode sheets separated by separator sheets, such as polypropylene membranes. In another embodiment, the battery cells can be cylindrical cells comprising a roll of multiple anode sheets and cathode sheets separated by separator sheets, such as polypropylene membranes.

### EXAMPLES

In the following Examples the impact of the Li electrodeposition rate on the morphology of resulting Li deposits on a brush-like 3-D host based on vertically aligned carbon nanofibers (VACNFs) grown on Cu foils is explored. VACNFs are N-doped graphitic carbon fibers grown by plasma-enhanced chemical vapor deposition (PECVD). They have a unique internal structure comprising, consisting of, or consisting essentially of conically stacked graphitic cups along the axis (commonly referred to as bamboo-like multi-walled carbon nanotubes (MWCNTs)). The side-wall surface of VACNFs is composed of electrochemically active graphitic edges which are spontaneously oxygenated in the air. It has been demonstrated that the VACNF/Cu can serve as an effective 3-D carbon host to enhance the stability and reversibility of LMAs. Given its desirable properties such as the high porosity (˜80%), vertically aligned pore structure and the lithiophilic surface, VACNF/Cu electrode serves as a model 3-D host for this study. Its well-defined vertical structure allows the observation of the microscopic morphology of infiltrated Li at different stages of Li plating and stripping.

It is first demonstrated that a higher pressure between the electrode/separator stack inside the coin-cells tends to induce densely packed Li morphology. The non-uniform internal pressure distribution and varied pressure among different coin cells may be the cause for discrepancies previously reported in the relevant literature. By consistently controlling the coin cell with a minimal pressure, the current study was able to investigate the intrinsic effect of the plating current density on the microscopic morphology of Li metal plated on both planar Cu and 3-D VACNF/Cu electrodes. The 3-D VACNF/Cu electrode clearly showed superior stability and improved reversibility in continuous plating/stripping cycling tests. The results unraveled the drastic change in Li morphology vs. the plating current density on both types of electrodes, following the classical nucleation and growth theory. Though lowering the local plating current density with the VACNF/Cu electrode exhibited enhanced stability in cycling tests, the formation of large irregular Li grains with the long noodle-like morphology poses a concern for dendrite growth and safety in practical LMBs that require much longer cycling lives. It was surprising that electrochemical characterization showed that the stripping current density also affected the electrode performance. By decoupling the plating and stripping current density at different values, the performance can be optimized by balancing the macroscopic electrochemical observation and microscopic morphology during Li plating/stripping.

1. Materials and methods
1.1 Chemicals and materials

Electrolyte (1.0 M LiTFSI in DOL/DME (1:1, v/v) with 1 wt % LiNO₃ additive) was purchased from Dodochem Limited (Suzhou, China). Copper foils (99.999%) were purchased from Fisher Scientific (Hampton, NH) and GoodFellow Corporation (Pittsburgh, PA). Li foil, CR2032 coin cell casings, spacers, and wave springs were purchased from MTI Corporation (Richmond, CA). Celgard 2400 separator was purchased from Celgard (Charlotte, NC).

1.2 Preparation of VACNF/Cu electrode

An 84 μm thick copper foil was used as the substrate for the growth of VACNFs. A 300 nm thick Cr barrier layer and a 30 nm thick Ni catalyst layer were sputter coated using a high-vacuum Perkin Elmer 4400 series magnetron sputtering system at UHV Sputtering Inc. (Morgan Hill, CA). VACNFs were grown using a DC-biased plasma enhanced chemical vapor deposition (PECVD) unit (Black Magic, Aixtron, CA) following the same procedure reported in the documents previously incorporated by reference. In brief, the substrate was heated to 500° C. at a rate of 200° C./min with ammonia gas at a flow rate of 250 sccm, at a pressure of 3.9 Torr. Under these conditions, a DC plasma at 510 V and 40 W was applied for 60 s to dewet and break the Ni film into randomly distributed Ni nanoparticles. Then, the temperature was increased to 750° C. at a rate of 250° C./min while 70 sccm acetylene gas was introduced as the carbon precursor along with ammonia, the etching/reducing gas to give a steady-state pressure of 4.8 Torr. The process was continued for 90 minutes to grow 15 μm long VACNFs on Cu. For some experiments, VACNFs of 15 μm length, grown for 120 minutes on 100 μm thick copper foil, with a 100 nm thick Cr barrier layer and a 24 nm thick Ni catalyst layer were used.

### 1.3 Materials Characterization

The morphology of the electrodes was studied using Topcon/ISIABT DS 130F FESEM (Akashi Beam Technology Corporation, Tokyo, Japan) and Helios NanoLab 660 (FEI, OR) with a focused ion beam (FIB) milling functionality. To image the electrodes after lithium plating/stripping, they were harvested from coin-cells by disassembling in an Ar-filled glovebox. The harvested electrodes were washed by immersing in DME several times. After drying in the antechamber of glovebox under vacuum, the FESEM samples were prepared back inside the glovebox. The prepared samples were then stored in a tightly sealed container filled with ultrapure Ar. The samples were only exposed to the ambient air for a few seconds during the transfer from the sealed container to the sample stage of the FESEM. Before FIB milling, a 2 μm thick Pt layer was deposited to protect the underneath structure from ion beam damage. The morphology of individual VACNFs was imaged using a Philips CM 100 TEM at a 100 kV acceleration voltage in the low dose mode at −175° C. using a Gatan cryo-holder. The VACNFs were transferred to TEM grids by scraping them from the electrode inside a glovebox. The TEM grids were stored in Ar-filled storage holders and plunged in liquid nitrogen without exposure to the air. This was followed by transferring the TEM grid to the cryo-holder using a cryo-station. The cryo-shield was used to prevent the sample from exposure to the air during the transfer from cryo-station to TEM.

1.4 Electrochemical characterization

VACNF/Cu or planar Cu foil electrodes of 15 mm in diameter were used as the working electrode to assemble half-cells using CR2032 casings. A 25 μm thick Celgard 2400 and a 0.60 mm thick Li foil were used as the separator and counter electrode, respectively. A 0.3 mm thick stainless steel wave spring (1.4 mm height) and two pieces of 0.2 mm thick stainless-steel disk spacers were used as mechanical supports to provide consistent pressure and good contact between the components. Cell assembly was done using an MTI hydraulic crimping machine by applying ˜750 psi pressure. The Li foils were polished using 200 and 400 grit sandpapers before assembling. 250 μL of 1.0 M LiTFSI in DOL/DME (1:1, v/v) solvent with 1 wt % LiNO₃ additive was used as the electrolyte. The half-cells were assembled in an argon-filled glovebox (Mbraun MB10 Compact, Stratham, NH) with oxygen and water levels below 0.5 ppm. To visualize the internal pressure inside coin cells, Fujifilm Prescale films (4LW, 3LW, 2LW, and LW) covering a range of pressures from 7.2 to 1400 psi were used in dry dummy cells with different compression %. The assembled half-cells were tested using a battery testing system (Neware, Shenzhen, China) at room temperature. Five cycles of Li intercalation/deintercalation at 50 μA were applied between 0.0 V and 1.0 V (vs. Li+/Li) before Li plating to activate the electrode. For the plating/stripping cycling tests, a capacity of 2.0 mAh/cm² was employed. The upper cut-off voltage for Li stripping was 1.0 V vs Li+/Li. The CE was determined by the ratio of the capacity of Li stripped to the capacity of Li plated, and it is expressed in percentage.

### 2. Results and Discussion

### 2.1 Preliminary Characterization

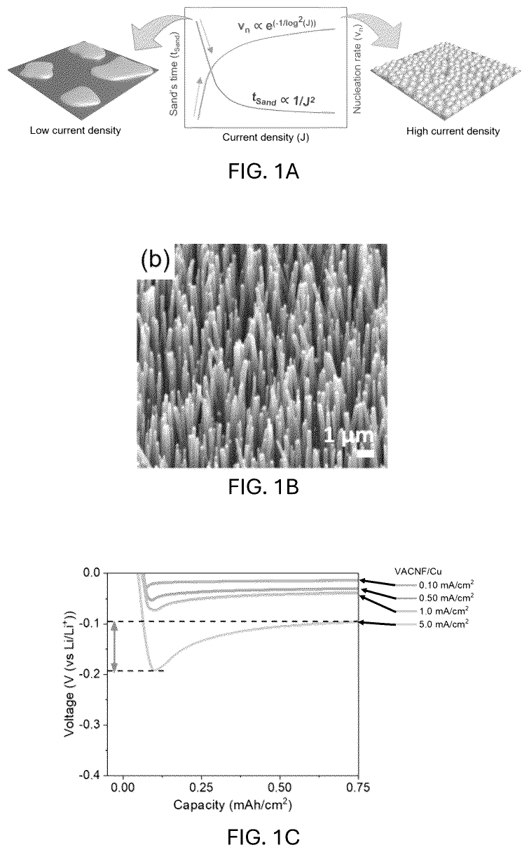

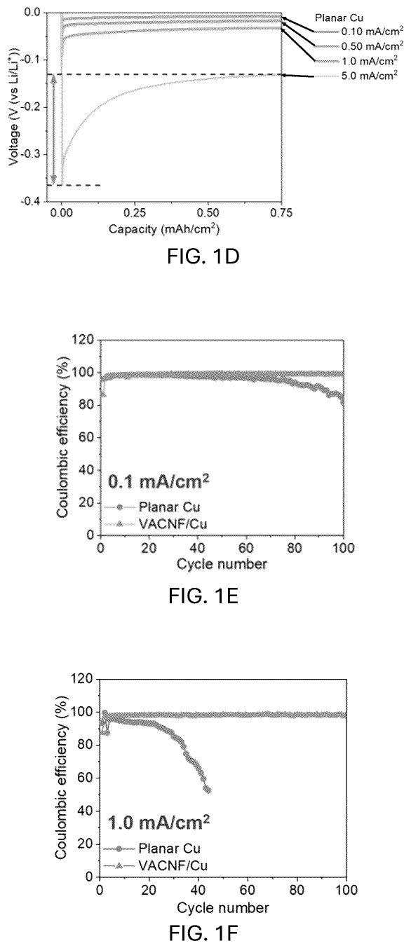

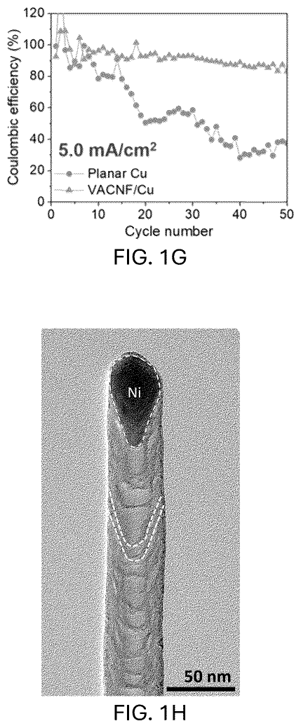

FIG. 1A illustrates the opposite trends of Sand's time -(t_{Sand}) and nucleation rate (vₙ) vs. the plating current density j. Sand's time is defined as the time that it takes for the Li⁺ ion concentration to deplete at the anode surface leading to the onset of ramified electric field and growth of dendrites. The relationship between t_{Sand} and the current density j is outlined in Equation 1:

$${t}_{Sand} = π {D}_{e} {( \frac{{z}_{c} {C}_{0} F}{2 {jt}_{a}} )}^{2} \qquad ( 1 )$$

where D_{c} is the effective diffusion coefficient, zc is the charge of cation (+1 for Li⁺ ion), C₀ is the Li⁺ concentration in the bulk electrolyte, and tu is the anion transference number. Sand's time is inversely proportional to j². Thus, with the use of high-surface-area 3-D current collectors, the decrease in local current density helps to extend the Sand's time compared to planar electrodes and hence delay the onset of dendrite growth. However, the decrease in j also reduces the nucleation overpotential ηₙ, the driving force for Li nucleation and growth, leading to decrease in the nucleation rate vₙ following Equation 2:

$${v}_{n} ∝ exp ( \frac{- 1}{{log}^{2} j} ) \qquad ( 2 )$$

Associated with this, the nucleation density ηₙ also drastically decreases as j is reduced.

Based on literature, it is commonly accepted that the electrodeposition of lithium at low current densities leads to growth of large inhomogeneous islands without dendrite formation. While most studies in literature focused on the homogeneity of the electric field which is superior at low current densities, the impact of the nucleation rate vₙ and nucleation density Nₙ are often overlooked. The nucleation process is critical for lithium electrodeposition since it occurs rapidly within the short time at the beginning of electrodeposition and the further growth mainly occurs at the nucleated sites rather than forming fresh nuclei on the uncovered surface. Given that 3-D current collectors inherently offer a lower local current density, it is expected that the nucleation density N, will be further reduced, which will significantly affect the morphology of Li plating.

VACNF/Cu comprises or consists of a well-defined brush-like structure as shown in FIG. 1B. The TEM image (FIG. 1H) of a representative VACNF shows the unique conically stacked graphitic cup structure under an inverse tear-drop-shaped Ni nanoparticle catalyst at the tip. This unique structure provides abundant electrochemically active graphitic edges exposed on the sidewall surface. The average diameter of the VACNFs used in this study was ˜154 nm and the length was controlled as ˜ 14 μm. Based on their high aspect ratio and density (˜ 1 x 109 fibers/cm²), it was estimated that the VACNF array provides ˜70 times higher surface area than a planar current collector. The individual VACNFs were perpendicular to the copper substrate and were well separated from each other by about 100-300 nm, resulting in a low-tortuosity structure with a high porosity of ˜ 79%. The VACNFs were found to be inherently doped with 7.3 at % of N across the whole CNF and 2.9 at % of O functionalized at the sidewall surface, which improved their lithiophilicity. These properties are desired to enhance the performance as a conductive 3-D host for LMAs.

FIGS. 1C and 1D show the typical galvanostatic voltage curves of the first Li plating step for VACNF/Cu and planar Cu electrodes, respectively, at different current densities. For the planar Cu, a sharp voltage dip was observed during the electrodeposition, indicating the fast nucleation of Li without any intercalation/alloying. In the case of VACNF/Cu, the voltage dip was delayed to appear at the capacities of ˜ 0.080 to 0.10 mAh/cm² due to partial Li intercalation into the graphitic structure of VACNFs. With the increase in plating capacity, the voltage increased and formed a plateau with lower overpotentials, indicating reaching the steady-state Li growth limited by mass transport of Li+ ions from the bulk solution. From these curves, lithium nucleation overpotentials (nn) were calculated as the potential difference between the lowest voltage dip and the following plateau. The nn was found to increase with the current density, consistent with Butler-Volmer kinetics. For VACNF/Cu, the nn was observed to be 13.6, 23.0, 33.8 and 95.2 mV for the current density of 0.10, 0.50, 1.0 and 5.0 mA/cm² respectively. Conversely, for planar Cu, the nn was found to be 33.6, 44.3, 58.6 and 234.3 mV for the same respective current densities. It is evident that the magnitude of nn was significantly smaller in 3-D VACNF/Cu than that of planar Cu electrode at all the tested current densities. This can be attributed to the lithiophilic nature and the high surface area of VACNF/Cu electrodes.

For further characterization, conventional symmetric plating/stripping cycling tests were performed on VACNF/Cu and planar Cu electrodes at varied current densities (FIGS. 1E-1G) with the plating and stripping current set at the same values. At the low current density with j =0.10 mA/cm², the cycling performance was relatively stable and lasted longer for both VACNF/Cu and planar Cu electrodes. VACNF/Cu exhibited a stable CE averaging around 98.8% for 100 cycles, which is equivalent to 4000 hours of cycling time. For the planar Cu, the CE declined to 81.5% after 100 cycles. Under a higher cycling rate with j=1.0 mA/cm², the average CE slightly dropped to around 98.0% for VACNF/Cu and the electrode was able to maintain a stable performance for 100 cycles. In comparison, the planar Cu failed quite early, with the CE dropped to 74.8% after 35 cycles. With further increase in the current density to j=5.0 mA/cm², the performance of the planar Cu further degraded rapidly from the beginning of the cycling. The VACNF/Cu exhibited a better performance in comparison to the planar Cu, but its CE decreased from ˜ 100% to ˜ 83% after 50 cycles along with much larger variations in each cycle. The observed declining trend in CE and stability vs. the plating/stripping rate is consistent with the prediction by the Sand's equation (Equation 1). From these results, it is concluded that the 3-D VACNF/Cu performs better than planar Cu at all cycling rates, which can be attributed to its 3-D conductive structure with superior lithiophilic nature to reduce Li dendrite formation. Here we focus on further study of the microscopic morphology of Li plating, which underlies the observed macroscopic performance enhancement in CE and cycle life.

2.2 Effect of plating/stripping kinetics on Li morphology
2.2.1 Effect on Li morphology by the internal pressure on the electrode surface

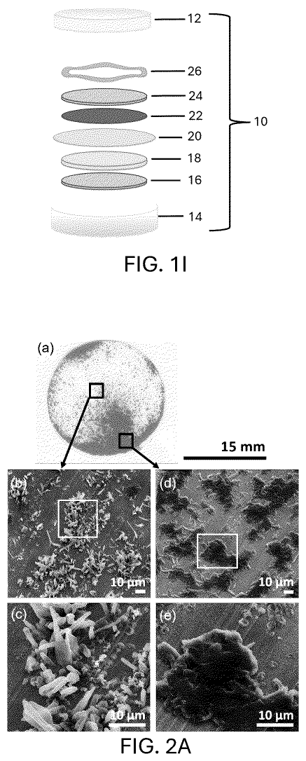

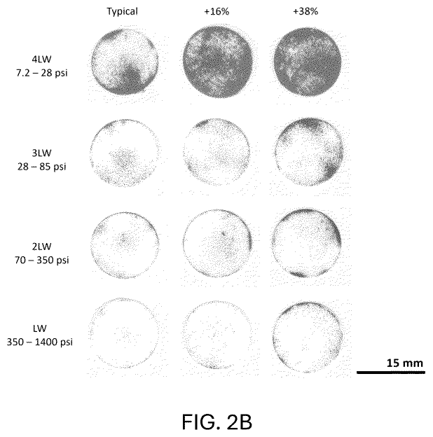

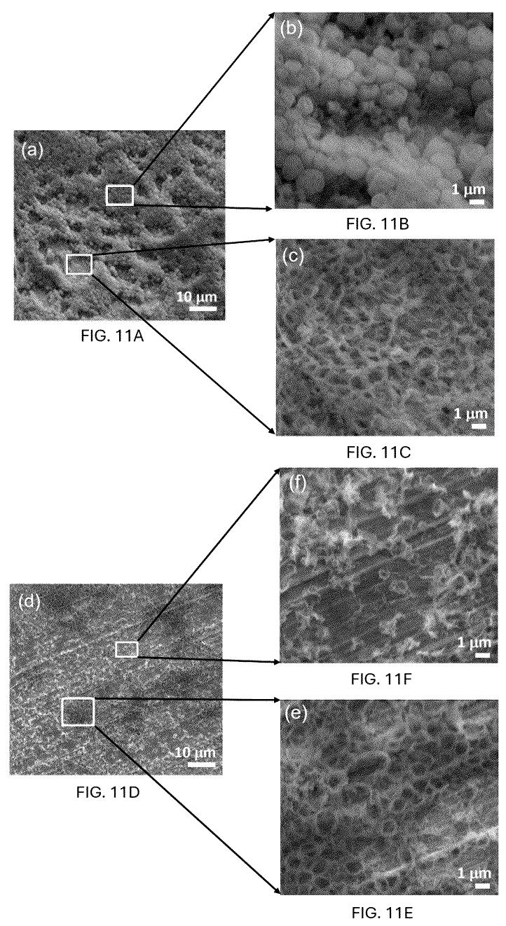

The goal was to carry out morphological analysis to understand how the current density affects the structure of Li plating and its correlation on the cell performance. However, the morphology of electrodeposited Li strongly depends on the pressure inside the cells. It is believed that the discrepancies in morphology reported in literature are largely attributed to the uncontrolled pressure or nonuniform distribution of the pressure inside the cell. FIG. 11 illustrates the internal configuration of the coin-cells 10 used in this study. As shown in FIG. 1I, the coin cell is a CR2032 coin battery comprising a CR2032 top can 12 and a CR2032 bottom can 14 that forms the casing. Each of the top can 12 and the bottom can 14 has a thickness of about 0.25 mm. A spacer 16 is placed directly on the bottom can 12, the spacer having a thickness of about 0.20 mm. Lithium foil 18 having a thickness of about 0.60 mm is placed on the spacer 16. A polypropylene (PP) separator 20 having a thickness of about 25 μm is placed onto the lithium foil 18. Next, the working electrode 22 having a thickness of about 100 μm is placed onto the PP separator 20. The working electrode can be either a planar Cu electrode or a VACNF/Cu electrode. An additional spacer 16 is placed on the working electrode 22 and a wave spring 26 having a height of about 1.4 mm is placed on the spacer 16. The top can 12 is then added to enclose the contents of the cell 10. As revealed by the optical image of a pressure-sensitive film (Prescale film by Fujifilm) used in a dry dummy CR2032 coin-cell, the pressure distribution inside the cell is highly nonuniform (FIG. 2A). A higher pressure was applied around the periphery than that at the center of the electrode disk. The morphological analysis of the electrode across its diameter was applied after plating 0.20 mAh/cm² of Li on the planar Cu disk at 0.10 mA/cm². The SEM images revealed that the plated Li had distinct morphologies at different locations. At the center of the electrode, the Li showed whisker or fibrous shapes, shown in images (b) and (c) of FIG. 2A. But at the spot close to the periphery, larger flat irregular Li islands were observed, shown in images (d) and (e) of FIG. 2A. To further validate the pressure effect, studies were conducted by constructing coin-cells with increased internal pressure. Optical images of pressure-sensitive films with different internal pressures are shown in FIG. 2B. With increase in compression % (as described in Table 1, below), the magnitude of internal pressure increases in both center and periphery but maintaining the non-uniform pressure distributions in coin-cells.

Since the wave spring 26 is the only compressible element, the compression percentage is calculated as the ratio of the change in height of wave spring 26 from the uncompressed state to the compressed state relative to its height in the uncompressed state.

$$Compression \% = \frac{{h}_{uncompressed} - {h}_{compressed}}{{h}_{uncompressed}}$$

where,
h_{uncompressed}=height of the wave spring 26 under uncompressed condition,
h_{compressed}=height of the wave spring 26 under compressed condition.

For the configuration as in FIG. 1I, the compression is only a few percent. To achieve 16% compression, an additional spacer of 0.20 mm thickness was used. While for 38% compression, the same quantity of elements as in FIG. 1I were used, but within a CR2025 cell casing.

TABLE 1
Compression % for different coin-cell configurations.

| | Total thickness | | Sealed | | |
|---|---|---|---|---|---|
| | of all components | | coin | | |
| | without | | cell | | |
| Sl. | compression | h_{uncompressed} | height | h_{compressed} | Compres- |
| No. | (mm) | (mm) | (mm) | (mm) | sion % |
| 1 | 3.025 | 1.4 | 3.0 | 1.375 | 1.8% |
| | | | | | (Typical) |
| 2 | 3.225 | 1.4 | 3.0 | 1.175 | 16% |
| 3 | 3.025 | 1.4 | 2.5 | 0.875 | 38% |

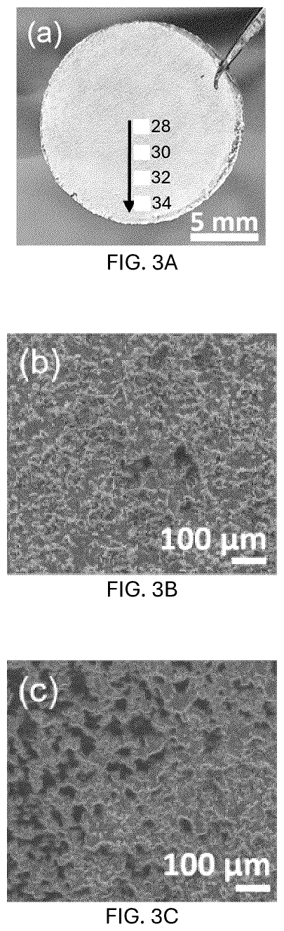

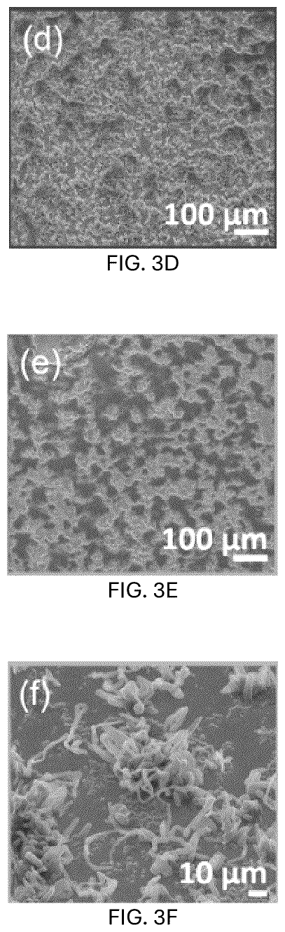

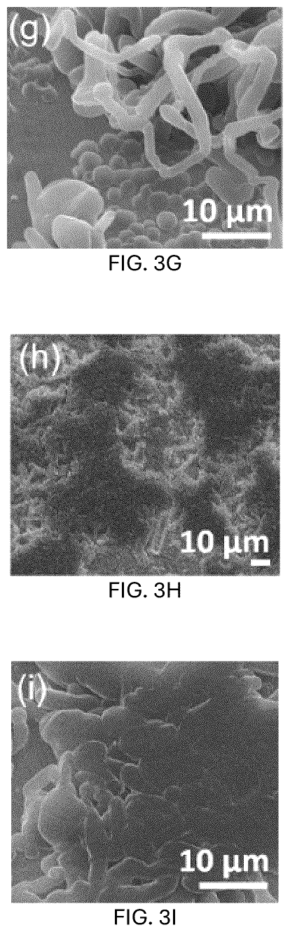

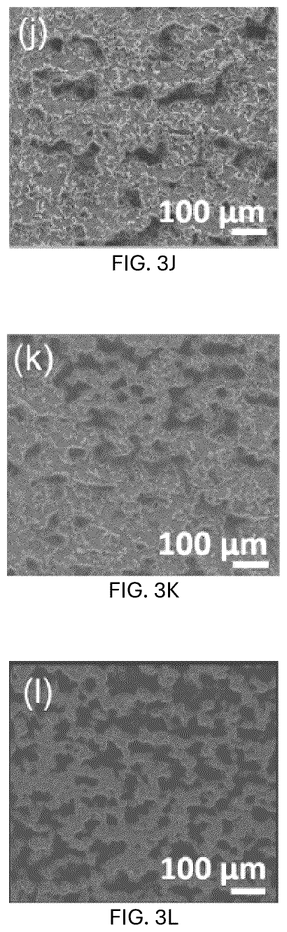

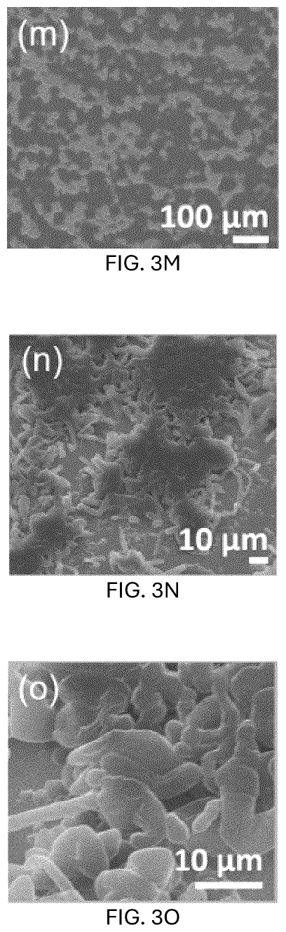

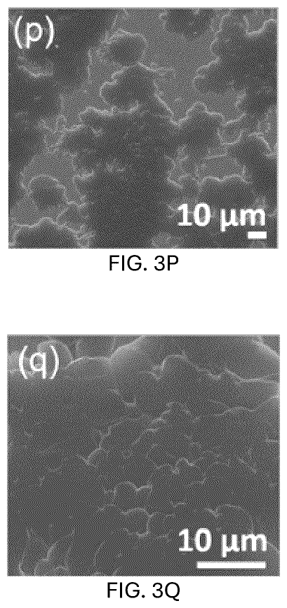

The morphologies of Li plated at 0.10 mA/cm² up to 0.75 mAh/cm² capacity were examined at four different spots from the center to the edge of the planar Cu disk electrode. FIGS. 3B-I were from a coin-cell with 16% higher compression which show a clear lateral expansion in the boundary of flat Li islands when moving from center to the edge. FIGS. 3B, 3F, and 3G are images taken from within area 28 on the coin cell. FIG. 3C is an image taken from within area 30 on the coin cell, FIG. 3D is an image taken from within area 32 on the coin cell, and FIGS. 3E, 3H, and 3I are images taken from within area 34 on the coin cell. Interestingly, the compressed islands show darker contrast in SEM images, reflecting the dense and more conductive Li metal grains while the uncompressed Li structures at the center show brighter features in SEM images. With further increase to 38% higher compression, flat Li islands could be observed at all spots from the center to the edge of the electrode along with the presence of some fibrous Li at the island boundaries (FIGS. 3J-Q). FIGS. 3J, 3N, and 30 are images taken from within area 28 on the coin cell. FIG. 3K is an image taken from within area 30 on the coin cell, FIG. 3L is an image taken from within area 32 on the coin cell, and FIGS. 3M, 3P, and 3Q are images taken from within area 34 on the coin cell. The fraction of compressed flat Li islands increases when moving from the center to the edge. Clearly, the higher pressure causes formation of flat Li islands while the lower pressure leads to the intrinsic fibrous Li morphology. This study confirmed the clastic deformation of Li deposits by pressure in the ether electrolyte that is commonly used for Li—S batteries. To exclude the pressure effect and examine the intrinsic morphology of Li plating, the following studies are carried out using the CR2032 coin-cell 10 shown in FIG. 11 in the compression configuration No. 1 in Table 1 and focused on the spots at the center of the electrode which has the minimal internal pressure.

2.2.2 Effect on the morphology by Li plating/stripping kinetics on planar Cu

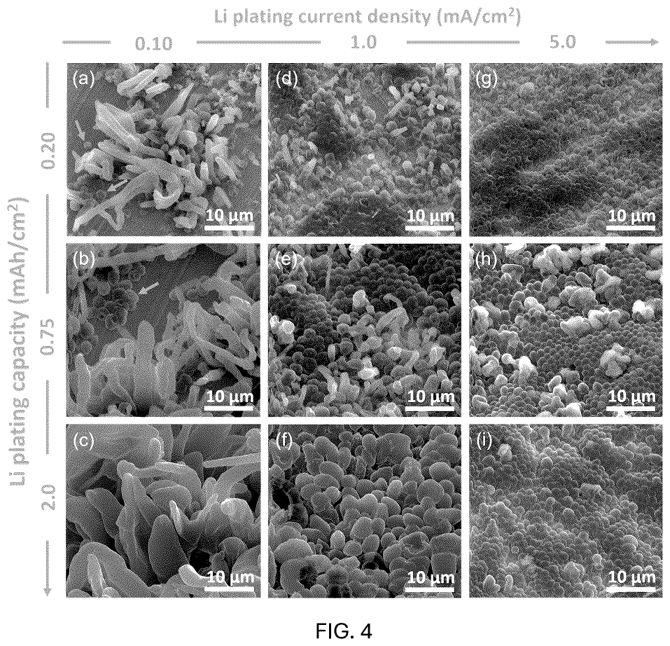

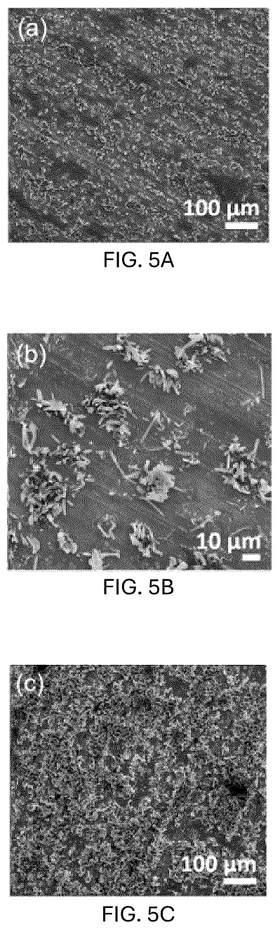

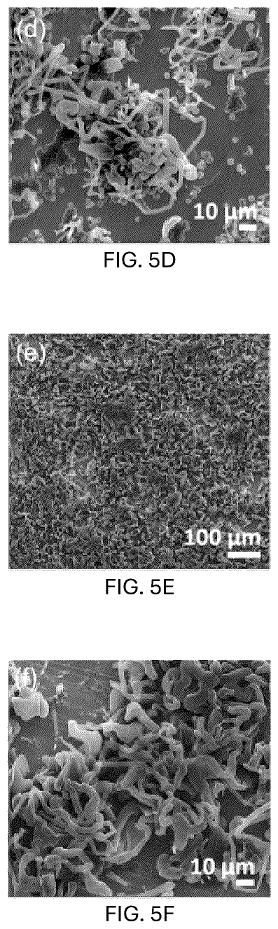

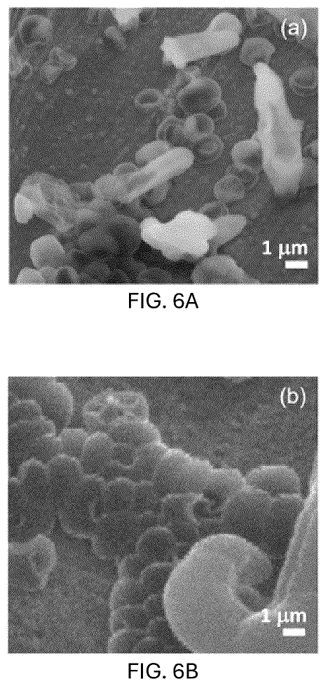

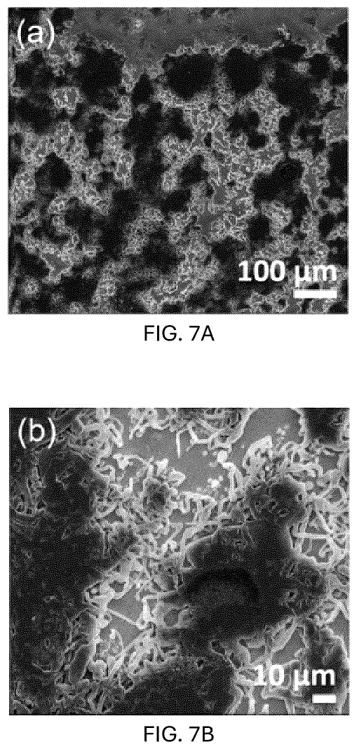

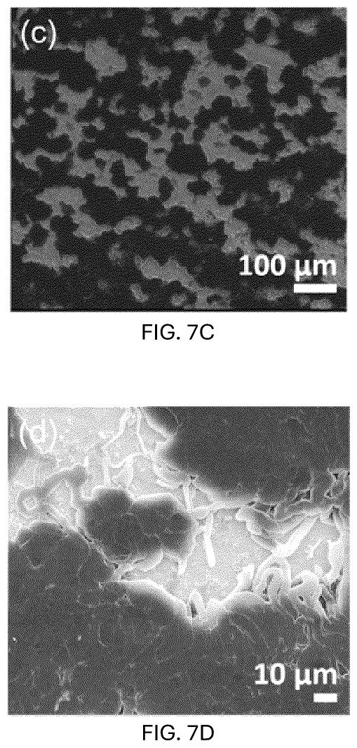

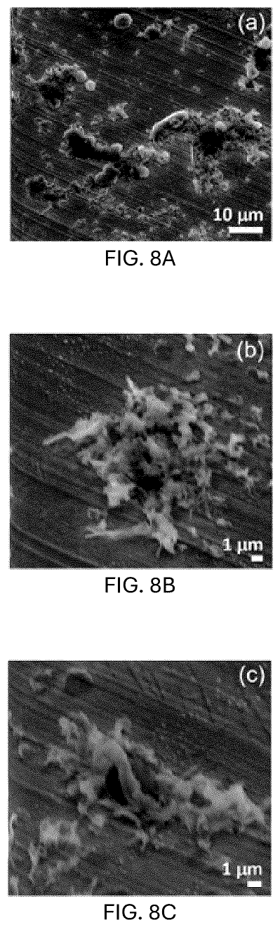

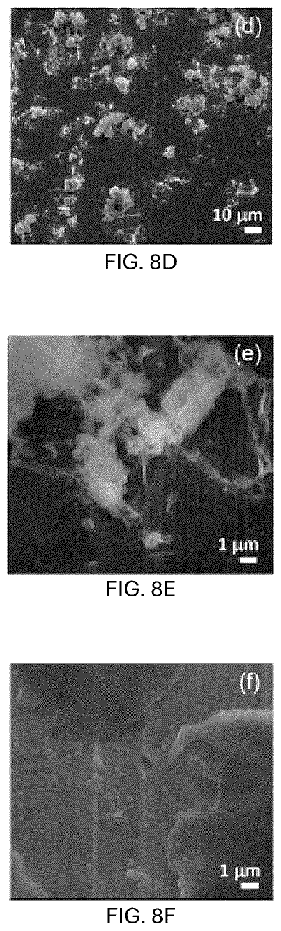

FIG. 4 shows FESEM images of Li electrodeposited on planar Cu electrodes under different current densities (0.10, 1.0 and 5.0 mA/cm²) up to varied plating capacities (0.20, 0.75 and 2.0 mAh/cm²). As shown in images (a) through (c) of FIG. 4, at the low current density of 0.10 mA/cm², the plated Li mainly presents as long fiber-like structures (about 1.5 μm in diameter and 3 to 20 μm in length) mixed with a small number of Li spheres of 1.7 μm in size (as highlighted by the blue arrows). FIGS. 5A and B further show that the initial Li plating at the low capacity formed sparse nonuniformly distributed fibrous particles with Li nucleation clustered in some spots while a large portion of bare Cu surface is uncovered. As the plating capacity was increased, the diameter and length of fiber-like Li continued to increase while the size of Li spheres only increased slightly (FIGS. 6A-B). The inhomogeneous growth rate on the different Li nuclei is probably due to the inhomogeneous electric field at different Li structures. Close to the periphery of the electrode, instead of fiber-like Li, larger smooth island-like Li deposits were present due to higher pressure at the electrode surface (FIGS. 7A-D). Closer observation of these Li islands revealed that they consisted of individual Li fibers that merged into the large flat islands. Some long fibers can be seen at the boundaries of the Li islands. After completely stripping the 0.75 mAh/cm² of Li plated at 0.10 mA/cm² and 1.0 mA/cm², respectively, clusters of dead Li and SEI skins were observed (FIGS. 8A-F). Their scarce distribution is consistent with the low nucleation density at 0.10 mA/cm² plating current density.

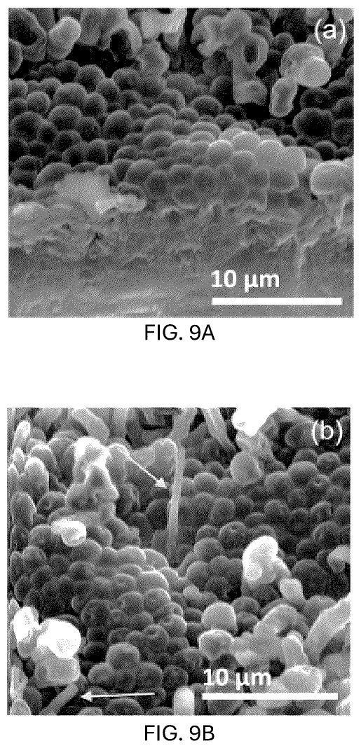

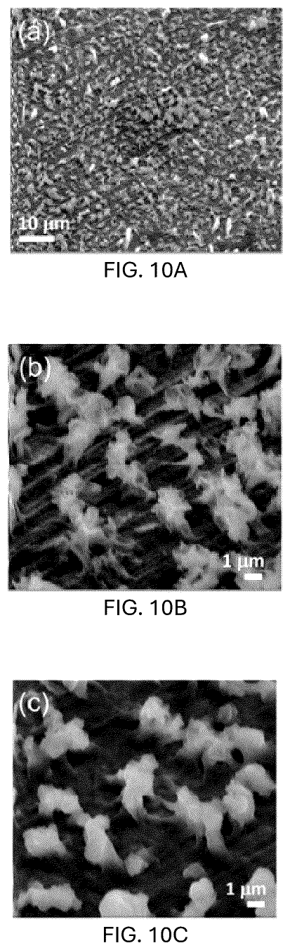

When the plating current density was increased to 1.0 mA/cm², the density of Li particles significantly increased, leaving a much smaller bare Cu surface area. The electrodeposited Li was dominated by spherical morphology (˜ 1.6 μm in diameter) with a smaller proportion of fiber-like Li (FIG. 4, images (d) through (f)). FIGS. 9A-B show that the spherical Li particles stack to form multiple layers. When the capacity was increased to 2.0 mAh/cm², further growth led Li particles to merge and form larger Li microcolumns (˜2.7 μm in diameter) (FIG. 4, image (f)). Upon completely stripping at the same current density (1.0 mA/cm²), dense dead Li/SEI structures with the irregular shapes of 0.6 to 3.7 μm in size were left on the Cu surface (FIGS. 10A-C), consistent with the dense Li nucleation sites when it was plated at 1.0 mA/cm².

A similar morphology of stacked spherical particles was observed when the current density was further increased to 5.0 mA/cm². But the particle size was reduced to ˜ 1.0 μm in diameter while the Cu surface was fully covered (FIG. 4, images (g) through (j)). When they were stripped completely at 5.0 mA/cm², a large amount of dead Li was observed as densely stacked spherical particles (FIGS. 11A-C). At areas where they got stripped more effectively, crumbled SEI remnants with circular outlines were found. However, when the stripping current density was reduced to 1.0 mA/cm², most spherical dead Li particles were removed (FIGS. 11D-F). Clearly, not only the plating current density but also the stripping current density is critical for the LMA performance. The application of a high stripping current density of 5.0 mA/cm² resulted in highly unstable cycling performance. It can thus be concluded that the inefficient stripping could be the cause for poor plating/stripping cycling performance of planar Cu at the high current density of 5.0 mA/cm² (FIG. 1G) compared to those at the lower current densities (FIGS. 1E & F). However, contrary to common assumptions, among the tested conditions, the homogeneity in Li nucleation and growth is poor at the low current density of 0.10 mA/cm². Despite the heterogeneous growth, the use of low current density for the stripping step during CE cycling helps to achieve a relatively more stable performance, partially mitigated the impact of the electrodeposited lithium morphology.

2.2.3. Effect on the morphology by Li plating/stripping kinetics on 3-D VACNF/Cu

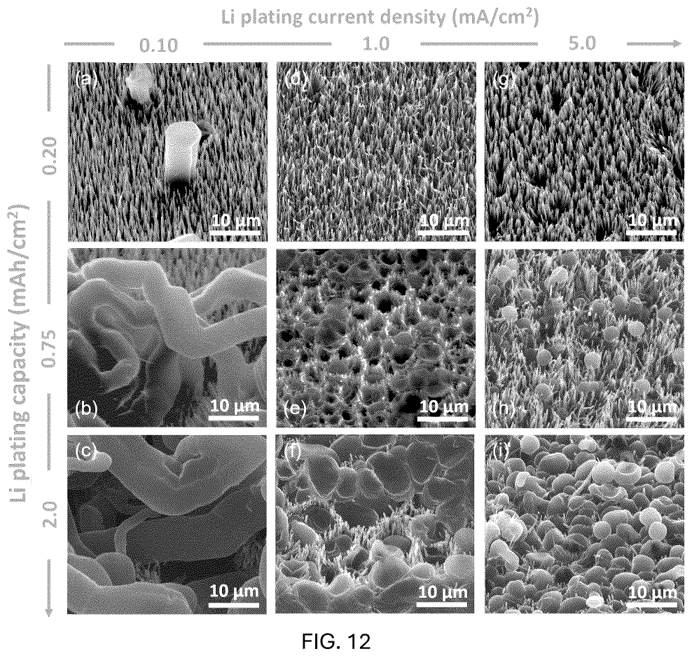

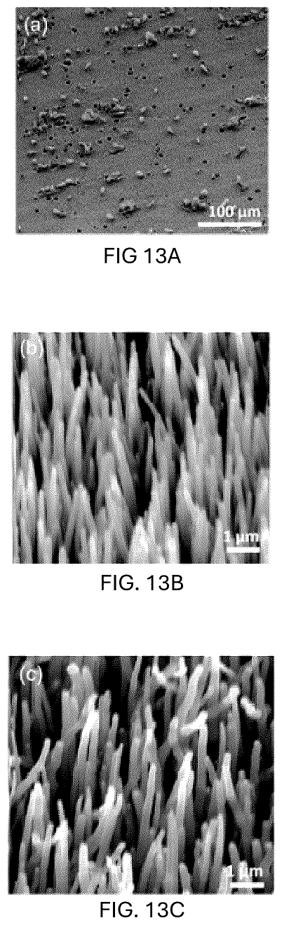

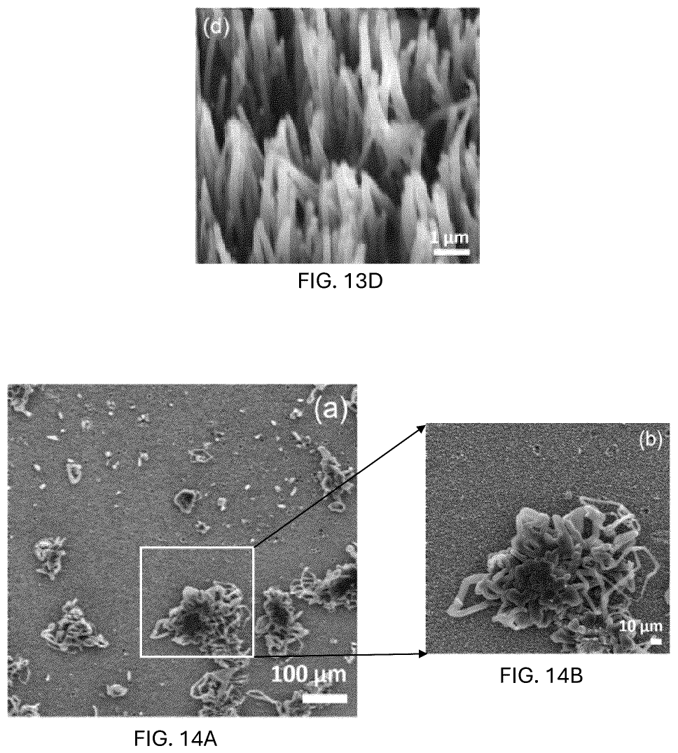

FIG. 12, images (a) through (i) show the FESEM images of Li electrodeposited at different current densities on the 3-D VACNF/Cu electrodes. When electrodeposition was done at 0.10 mA/cm², sparsely distributed vertical Li microcolumns (or micropillars) of ˜ 5.5 μm in diameter and height up to ˜35 μm were observed even at a very low plating capacity of 0.20 mAh/cm² (FIG. 12, image (a), 13A). An approximately equal number of darker recessed micro-spots were also observed in FIG. 13A, corresponding to the dense Li micro-grains infiltrated in the VACNF arrays. In the space between the bright protruding Li microcolumns and darker dense infiltrated micro-grains, the VACNF array is dominated by brush-like structure (FIG. 13B) similar to the pristine VACNF arrays (FIG. 1B) but with a small degree of bundling due to the capillary force during drying the liquid electrolyte and rising solvent. The fact that the VACNF array can maintain the vertical structure without severely collapsing into micro-bundles (or tipi-like structures) indicates that each VACNF is coaxially coated with nanoscale lithium or SEI sheaths which enhances its mechanical strength against the applied pressure in the coin-cell and the capillary forces exerted by the liquid electrolyte and the solvent during cell assembly/disassembly and rinsing processes.

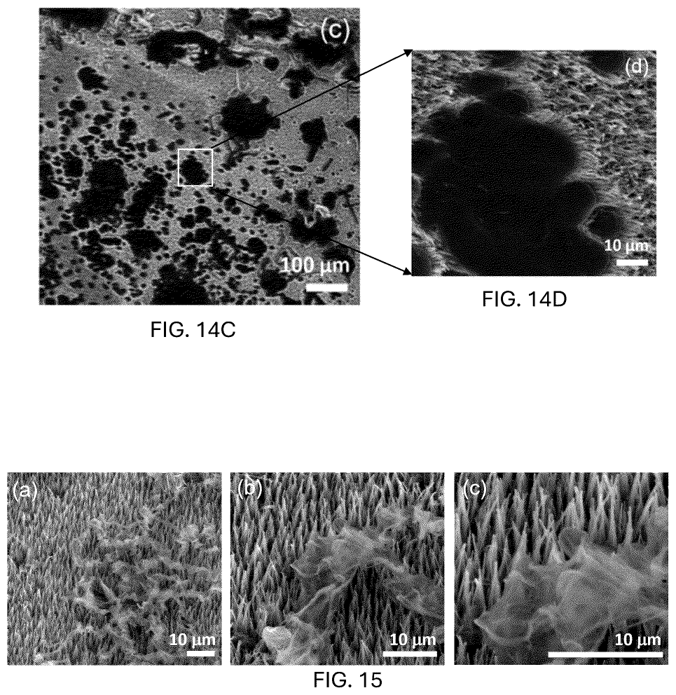

With further plating to 0.75 mAh/cm², the protruding microcolumns quickly grew in length, eventually folded along kinks into noodle-like structures on top of the VACNF array (FIG. 12, image (b)). Further growth was witnessed as the plating capacity was increased to 2.0 mAh/cm². The diameter of the Li fiber also increased to ˜ 8.0 μm during this process but at a rate much slower than the increase in the length. On the periphery, due to higher internal pressure, dense Li islands were observed (FIGS. 14C-D). As shown in FIG. 15, when completely stripped at 0.10 mA/cm², collapsed thin SEI skins from the surface of the noodle-like Li structure were left behind.

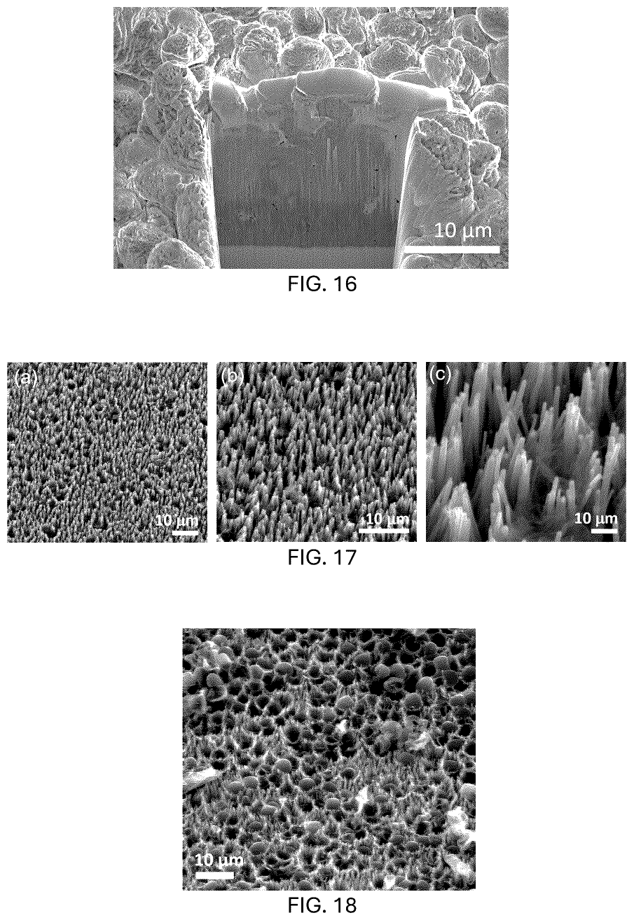

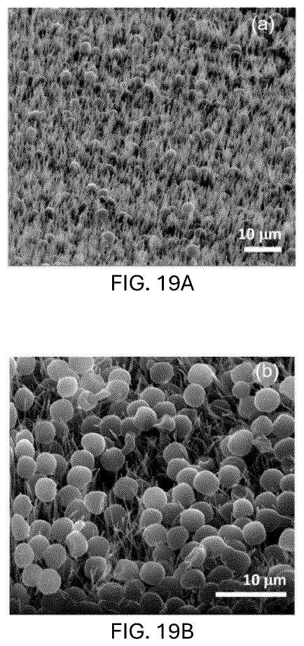

When the plating current density was increased to 1.0 mA/cm², the initial growth of tall Li microcolumns was significantly suppressed (FIG. 12, image (d)). The plated Li at the low capacity (0.20 mAh/cm²) was dominated by coaxial Li sheath around each VACNFs (FIGS. 12, image (d) and 13C). At the plating capacities was increased to 0.75 mAh/cm², smaller (˜ 3.0-4.9 μm in diameter) and shorter Li microcolumns were formed inside the VACNF array (FIG. 12, image (c)). At the even higher plating capacity of 2.0 mAh/cm², the diameter of the Li microcolumns further increased and merged into larger solid columns of ˜ 4.8-10 μm in diameter which encapsulated the VACNFs inside (FIG. 12, image (f)). The morphology change is consistent with the prediction by the classical theory of heterogeneous nucleation and growth, i.e., a higher nucleation rate vₙ and a higher nucleation density Nₙ would be obtained at the higher plating current density (following the blue curve in FIG. 1B). It is to be noted that the height of Li microcolumns plated at j=1.0 mA/cm² was approximately leveled with the top surface of VACNF arrays and did not exceed ˜20 μm. From the FIB-SEM image (FIG. 16), it can be observed that the columnar Li infiltrates the spaces among VACNFs to form dense solid structures without observable pores. FIG. 17 shows that no SEI skins were left on top of VACNF arrays after stripping the plated 0.75 mAh/cm² Li. Instead, coaxial SEI sheaths were observed around the VACNFs that were buried within the Li microcolumns. Similar results were also observed at the plating current density of 0.50 mA/cm² (FIG. 18).

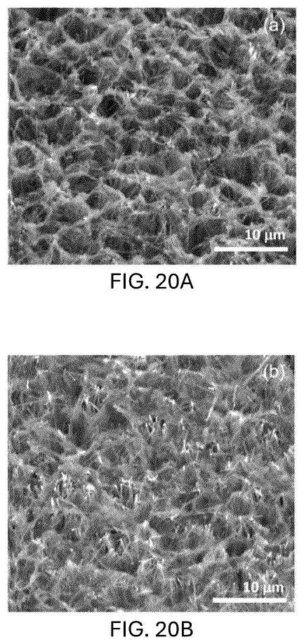

When the current density was increased further to 5.0 mA/cm², small number of infiltrated Li micro-columns inside the VACNF array (FIG. 12, image (g)) and coaxial Li sheath (FIG. 13D) around individual VACNFs were observed at the low plating capacity of 0.20 mAh/cm². As more Li was plated, in addition to the columnar Li infiltrated into the VACNF array, spherical Li particles of 2.4 to 3.2 μm in diameter were observed above the VACNF array and attached to the VACNF tips as shown in FIG. 12, image (h) through (i) and 19A-B. This could signify the onset of more pronounced electric fields near the VACNF tips at high current densities, which might lead to rapid spherical Li deposition on top instead of infiltration into VACNF arrays. The application of artificial SEIs along the length of VACNFs with a thickness gradient that decreases from the tip to the base could be an interesting strategy to explore in order to minimize the formation of spherical Li particles on VACNF tips. When stripped, the spherical Li particles left behind crumbled SEI skins with circular borders (FIGS. 20A-B) similar to those observed on the planar Cu electrode. This implies that the spherical Li particles are electrically connected to the tip of VACNFs. In contrast to that on the planar Cu, patches of unstripped dead Li were not observed in VACNF/Cu even after stripping at 5.0 mA/cm². This suggests an improved stripping efficiency of plated Li on VACNFs, probably due to the better electrical connectivity in the 3-D carbon host.

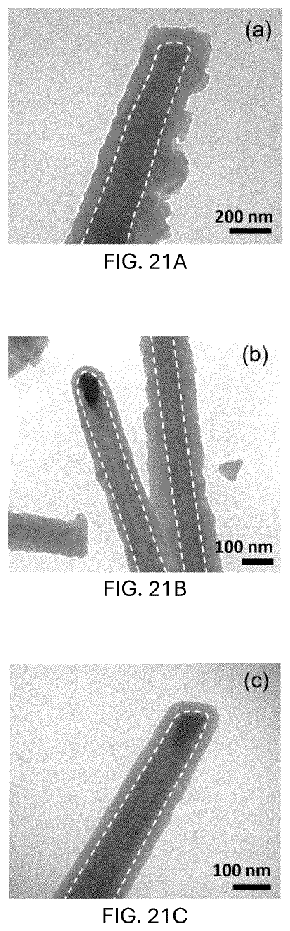

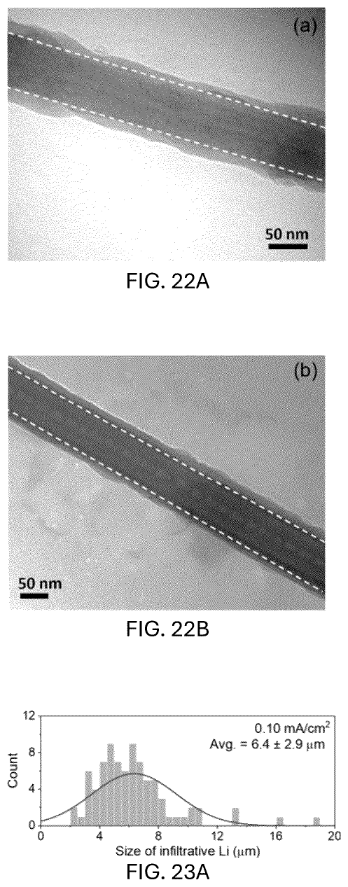

From FIG. 12, it can also be observed that some VACNFs were not engulfed by the infiltrated columnar Li in the samples, particularly at low plating capacities. After plating with 0.75 mAh/cm² Li, these VACNFs were scraped off and analyzed using cryo-TEM (FIGS. 21A-C). It was found that, at all the tested current densities, there exists a co-axial sheath of electrodeposited Li on individual VACNFs. The thickness of the Li sheath ranges between ˜20 and ˜110 nm. After stripping, wrinkled SEI skins of 10-20 nm in thickness wrapping around the VACNFs can be observed (FIGS. 22A-B). The formation of such homogeneous coaxial Li sheath illustrates the lithiophilic nature of the graphitic edges of N-and O-doped VACNFs. The coaxial Li sheath formed quickly at the initial plating period up to about 0.20 mAh/cm² plating capacity at all plating current densities as shown in FIG. 12, images (a), (d), and (g), and 13B-D. However, the infiltrative columnar Li grew preferentially in the following plating period and thereby attributed to the dominant plated capacity when the plated Li capacity exceeded 0.20 mAh/cm².

2.2.4 Analysis of the Li grain size distributions

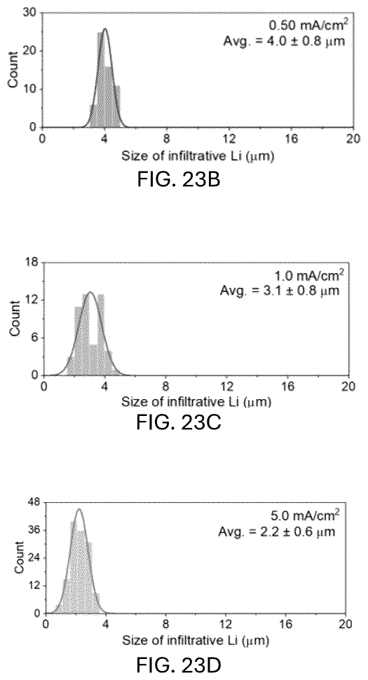

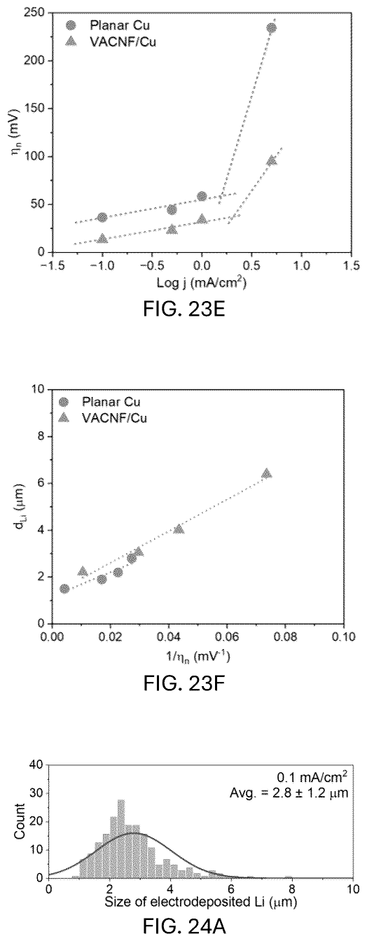

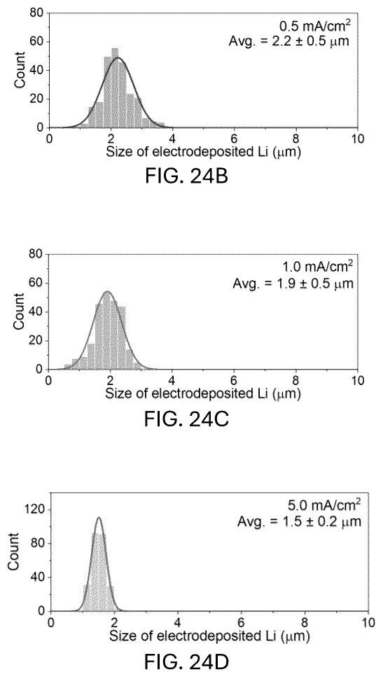

The size distribution of electrodeposited Li grains vs. the current density on VACNF/Cu and the planar Cu is depicted in FIGS. 23A-D and 24A-D, respectively. Only samples with a plating capacity of 0.75 mAh/cm² were selected for the particle size analysis since the grains were well separated. At the plating current density j=0.10 mA/cm², the average diameter of electrodeposited fibrous Li on VACNF/Cu was 6.4 μm. With increase in current densities to 0.50, 1.0, and 5.0 mA/cm², the average grain size (of the micro-columnar structure or spheres) was reduced to 4.0, 3.1, and 2.2 μm, respectively. In the case of planar Cu, the relationship between Li grain size and the current density j followed a similar trend with the average sizes of 2.8, 2.2, 1.9, and 1.5 μm at j=0.10, 0.50, 1.0, 5.0 mA/cm², respectively. The Li grain size on the VACNF/Cu host is significantly larger than that of planar Cu at all the tested current densities. This can be attributed to the lower local current density following the Sand's equation (Equation 1). The larger grain size, columnar morphology and improved electrical connectivity enabled by the VACNF/Cu host are beneficial in reducing undesired side reactions and boosting Li plating/stripping reversibility. This explains the enhanced stability in electrochemical cycling tests (FIGS. 1F-G). It needs to be highlighted that the distribution at 0.10 mA/cm², with a relative standard deviation (RSD) of ˜ 44%, is much broader compared to that at higher current densities. This conveys a heightened heterogeneity at low current densities leading to sparse nucleation.

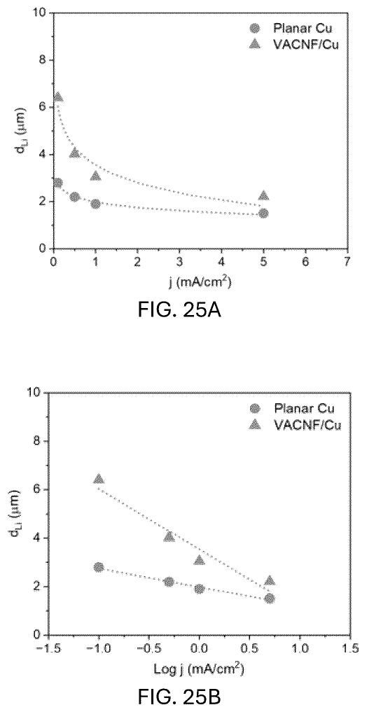

For heterogeneous nucleation, the critical nuclei size (r_{crit}) is inversely proportional to the nucleation overpotential ηₙ as given by Equation 3:

$${r}_{crit} = \frac{2 Υ {V}_{m}}{F \vert {η}_{n} \vert} \qquad ( 3 )$$

where Υ is the surface energy of Li-electrolyte interface, Vₘ is the molar volume of Li, and F is the Faraday's constant. The relationship between the current density j and the nucleation overpotential ηₙ is given by the Tafel equation, a special case of Butler-Volmer equation at low and moderate current densities:

$${η}_{n} = A + B ( log j ) \qquad ( 4 )$$

where A and B are constants. A linear relationship between nn and log j for j=0.10 to 1.0 mA/cm² is indeed shown in FIG. 23E. At j=5.0 mA/cm², deviation in the linear relationship was observed due to the change from kinetic-limited regime to mass-transfer limited regime. Clearly, the deviation observed on the planar Cu electrode is much larger than that on VACNF/Cu. Equations 3 and 4 predict that rerit is inversely proportional to the log j. FIGS. 23F and 25A-B show the same trend, with the Li grain size (dui) at 0.75 mAh/cm² plating capacity inversely proportional to log j and nn. This reveals that uniform Li nuclei can be obtained at proper plating current density. It is worth noting that the average Li grain size on VACNF/Cu deposited at 1.0 mA/cm² is much larger than those deposited on Cu at the low current density of 0.10 mA/cm². This further validates the lower nn offered by the 3-D VACNF/Cu electrode, which improves the Li plating/stripping reversibility.

### 2.3 Optimal Morphology for High Performance

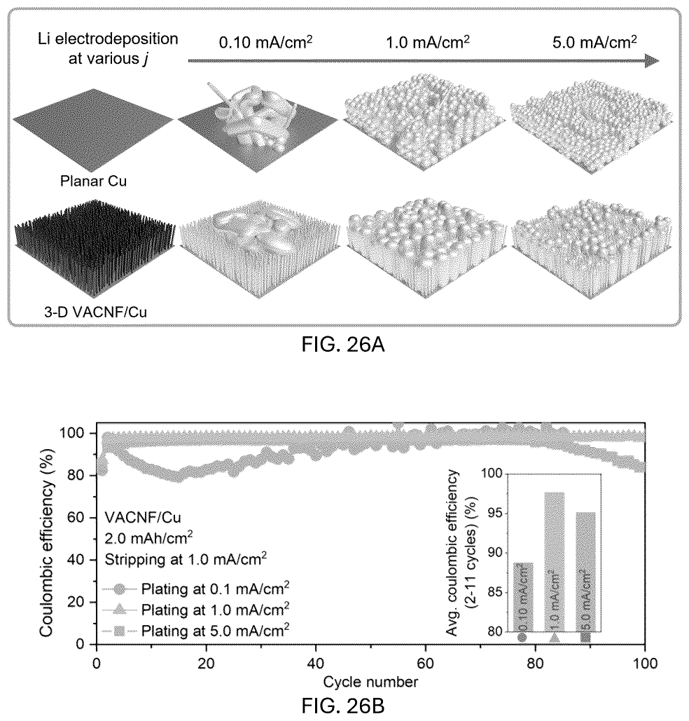

Based on the earlier discussion, the morphologies of electrodeposited Li on VACNF/Cu and planar Cu electrodes under the tested conditions are summarized in FIG. 26A. The overall process is highly heterogeneous and can be affected by both the structure of current collectors and the electrochemical deposition conditions, but it is consistent with the classical nucleation and growth theory. On planar Cu, at the low current density, the initial Li nucleation density is very low, but Li rapidly grows at these nucleation sites into large irregular grains consisting of clustered long fibers. With the increase in the current density, the nucleation density is increased, accompanied by the decrease in the nucleus size to form uniformly distributed spherical particles (of a few microns in size) with presence of a small number of fiber-like structures. On the other hand, on the 3-D VACNF/Cu electrode, lithium is initially deposited as thin coaxial sheaths around each VACNFs at all plating current densities. When the plating capacity is larger than 0.10 mAh/cm² at a low current density (≤0.10 mA/cm²), sparse columnar Li forms, which quickly grows into long fibers folded and laid over the VACNF array as more Li is plated. At the moderate plating current density (˜ 1.0 mA/cm²), Li quickly forms columnar structure (a few microns in diameter) that infiltrate into the space among VACNFs. The microcolumns grow laterally and merge into larger grains that are mostly retained inside the VACNF array. When a high current density (5.0 mA/cm²) is applied, the density of columnar Li increases accompanied by a reduction in their diameter. In addition to the columnar Li, a significant amount of Li is deposited on the tip of VACNFs as spherical particles (with a unform diameter of a few microns).

The fiber-or noodle-like Li plated at low j is considered undesirable as it leads to porous deposition and inefficient stripping. Contrary to this, such Li morphology exhibits higher CE and better stability during plating/stripping cycling (as shown in FIG. 1E). On the other hand, even though more unform and smaller Li particles can be achieved on VACNF arrays at the high current density of 5.0 mA/cm², it exhibits lower cycling stability (as shown in FIG. 1G). The microscopic morphology and the macroscopic cycling tests seem to point the opposite directions for optimizing the performance. However, it is to be noted that the earlier cycling tests employed a symmetric protocol, i.e., having the identical current densities for Li plating and stripping processes. The stripping process at the low current density may not be an issue but stripping at a high current density has been shown to produce a larger amount of dead Li Therefore, it is necessary to decouple the plating and stripping conditions to assess the stability of different Li morphologies. For this purpose, CE cycling tests were conducted on planar Cu and VACNF/Cu electrodes plated with 2.0 mAh/cm² Li using different plating current densities but stripped at a fixed moderate current density of 1.0 mA/cm².

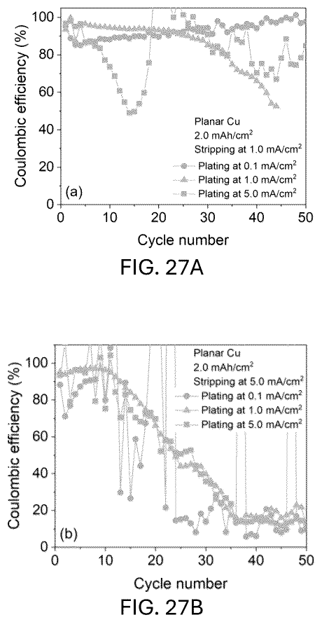

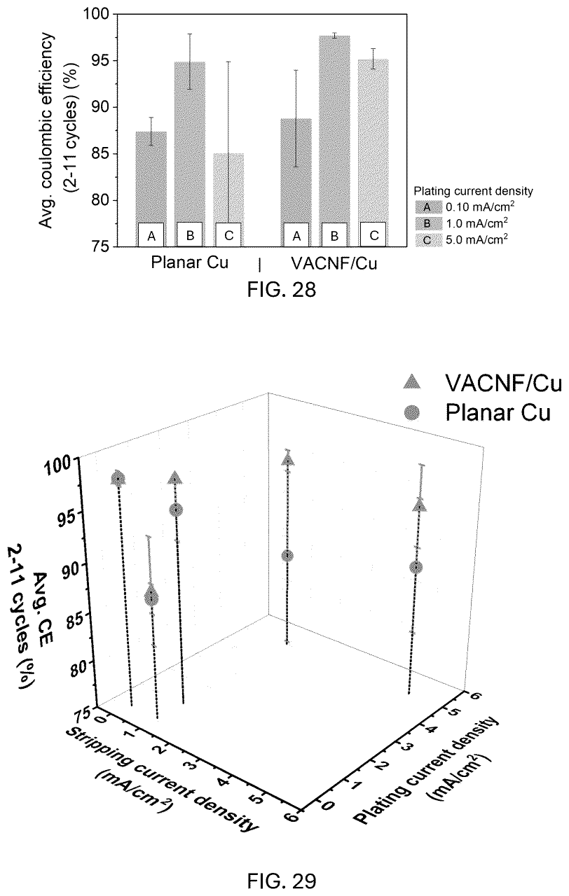

As shown in FIG. 26B, the cycling was stable for the VACNF/Cu electrodes plated at 1.0 and 5.0 mA/cm² which were associated with micro-columnar Li morphologies. The average CEs (from cycles 2-11) were around 97.8% and 95.2% for 1.0 and 5.0 mA/cm², respectively. The VACNF/Cu electrode at 0.1 mA/cm² plating current density exhibited the worst performance, with the CE starting to decline from the beginning of cycling and drop below 80% in the 15th cycle. After that, the CE started to increase and reached ˜ 100% after 40 cycles but with a large variation, possibly owing to the reconnection of accumulated dead Li. The average CE (cycles 2-11) is only 88.1%. This shows that the large noodle-like Li morphology may not exhibit a high cycling performance if the stripping current density is raised to a moderate level. In comparison, the cycling stability was inferior on planar Cu electrodes at all conditions (FIG. 27A) in similar decoupled plating/stripping studies. The planar Cu was unable to support the moderate stripping rate at 1.0 mA/cm² and was even worse at the stripping current density of 5.0 mA/cm² (FIG. 27B). Overall, as illustrated in FIGS. 28 and 29, the micro-columnar Li morphology infiltrated in the VACNFs achieved at the moderate Li plating current density (j=1.0 mA/cm²) exhibited the highest performance with an average CE of ˜98% (cycles 2-11). The Li spheres deposited on VACNF tips by the high current density (j=5.0 mA/cm²) gave a slightly lower CE (˜95%). The noodle-like Li morphologies plated at the low current density (j=0.10 mA/cm²) present the lowest CE (˜88%). This unveils that a lower plating current density is not always better for LMA operations, which is against the general presumption based on the Sand's equation (Equation 1). This provides an insight that factors other than lowering the local current density underlie the enhanced reversibility of Li plating/stripping on 3-D conductive anodes. To improve the nucleation density under low current densities and to induce dense Li structures, highly lithiophilic coatings could be applied to host surfaces.

### 3. Conclusion

In summary, the correlation of the microscopic morphologies of electrodeposited lithium metal with the macroscopic performance in lithium plating/stripping cycling tests has been illustrated. The VACNF arrays were used as a model 3-D conductive carbon host with a well-defined vertically aligned low-tortuosity structure to compare with the planar Cu current collector. The 3-D VACNF host indeed provided much higher stability and reversibility for Li plating/stripping. The pressure on the electrode surface inside the coin-cells was found to significantly affect the morphology of Li plating, leading to discrepancies in literature. By excluding this factor, the intrinsic Li morphologies were studied at different plating current densities. It was found that Li plating on both VACNF array and planar Cu electrodes follows the classical nucleation and growth theory, with the nucleation density, nucleation rate, critical nucleation size and Li morphology regulated by the nucleation overpotential which was proportional to the logarithm of the plating current density. At the low plating current density (≤0.10 mA/cm²), it tended to form sparse irregular grains of fibrous Li. At the moderate plating current density (˜ 1.0 mA/cm²), it formed uniform smaller micro-columnar Li deposits. When a high plating current density (˜ 5.0 mA/cm²) was used, some Li spheres started to form at the VACNF tips. In contrary to the Sand's equation which illustrates that a lower plating current density is always beneficial in suppressing Li dendrite formation, the morphology of Li deposits was more uniform at the moderate to high plating current densities, pointing to the opposite direction in optimizing lithium plating/stripping. It was found that these seemingly contradictory trends were largely due to the neglected factor that stripping processes worked better at the lower current density. In conventional cycling tests, the stripping and plating current densities were set at the same values and thus lower plating/stripping current densities seemed to exhibit better cycling stability. By decoupling these two variables and fixing the stripping current density at ˜1.0 mA/cm², it was unraveled that the Li metal deposit with more uniform microscopic morphology at the moderate plating current density (˜1.0 mA/cm²) exhibited the highest performance. This provides new insights in optimizing the performance of LMAs based on 3-D conductive hosts.

We claim:

1. A method of operating a battery having an anode comprising a current collector onto which metal is plated, the method comprising:
applying to the battery cell a charging electrical current having a first current density thereby reducing ions of the metal contained within an electrolyte at the anode and plating the anode with the metal; and
withdrawing from the battery cell a discharging electrical current having a second current density thereby oxidizing and stripping the metal from the anode and dispersing the ions of the metal into the electrolyte,
wherein the first current density is different from the second current density.

2. The method of claim 1, wherein the metal comprises a metal selected from the group consisting of lithium, sodium, potassium, and zinc.

3. The method of claim 2, wherein
(a) when the metal is sodium, the electrolyte comprises NaPF₆ in a mixed ethylene carbonate/propylene carbonate solvent, or sodium perchlorate (NaClO₄) in propylene carbonate solvent;
(b) when the metal is potassium, the electrolyte comprises potassium bis(fluorosulfonyl) amide; and
(c) when the metal is zinc, the electrolyte comprises ZnSO₄, Zn (ClO₄)₂, or zinc trifluoromethanesulfonate (ZnCF₃SO₃).

4. The method of claim 1, wherein the anode comprises a three-dimensional current collector, wherein the three-dimensional current collector comprises a plurality vertically aligned carbon nanofibers (VACNF) or a nanostructured porous conductive material comprised of carbon, nickel, copper, and/or steel.

5. The method of claim 1, wherein the first current density is from about 0.10 mA/cm² to about 10 mA/cm² and the second current density is from about 0.10 mA/cm² to about 2.5 mA/cm², wherein the first current density is greater than the second current density.

6. The method of claim 1, wherein the step of applying the charging electrical current to the anode is performed at a plating capacity of at least 0.2 mAh/cm².

7. The method of claim 1, wherein the anode exhibits an average Coulombic Efficiency (CE) of at least 80% after 100 cycles of the applying and withdrawing steps.

8. The method of claim 1, wherein the step of applying the charging electrical current to the battery cell results in formation of a substantially uniform layer of the metal on the anode, wherein the substantially uniform layer of the metal on the anode comprises micro-columnar deposits of the metal.

9. A method of operating a battery having an anode comprising a current collector onto which lithium is plated, the method comprising:
applying to the battery cell a charging electrical current having a first current density thereby reducing lithium ions contained within an electrolyte at the anode and plating the anode with the lithium; and
withdrawing from the battery cell a discharging electrical current having a second current density thereby oxidizing and stripping the lithium from the anode and dispersing the ions of the metal into the electrolyte,
wherein the first current density is greater than the second current density.

10. The method of claim 9, wherein the anode comprises a three-dimensional current collector, wherein the three-dimensional current collector comprises a plurality vertically aligned carbon nanofibers (VACNF), or wherein the three-dimensional current collector comprises a nanostructured porous conductive material comprised of carbon, nickel, copper, and/or steel.

11. The method of claim 9, wherein the first current density is from about 0.10 mA/cm² to about 10 mA/cm² and the second current density is from about 0.10 mA/cm² to about 2.5 mA/cm².

12. The method of claim 9, wherein the step of applying the charging electrical current to the anode is performed at a plating capacity of at least 0.2 mAh/cm².

13. The method of claim 9, wherein the anode exhibits an average Coulombic Efficiency (CE) of at least 80% after 100 cycles of the applying and withdrawing steps.

14. The method of claim 9, wherein the step of applying the charging electrical current to the battery cell results in formation of a substantially uniform layer of the metal on the anode, wherein the substantially uniform layer of the metal on the anode comprises micro-columnar deposits of the metal.

15. A method of cycling a battery between states of charging and discharging, the battery comprising an electrolyte, a lithium-less current collector comprising a three-dimensional nanostructured material as an anode, and a lithiated cathode, the method comprising:
applying to the battery cell a charging electrical current having a first current density thereby reducing lithium ions contained within the electrolyte at the anode and plating the current collector with the lithium; and
withdrawing from the battery cell a discharging electrical current having a second current density that is less than the first current density thereby oxidizing and stripping the lithium from the current collector at the anode and dispersing the lithium ions into the electrolyte.

16. The method of claim 14, wherein the first current density is from about 0.10 mA/cm² to about 10 mA/cm² and the second current density is from about 0.10 mA/cm² to about 2.5 mA/cm².

17. The method of claim 14, wherein the step of applying the charging electrical current to the anode is performed at a plating capacity of at least 0.2 mAh/cm².

18. The method of claim 14, wherein the three-dimensional nanostructured conductive material of the current collector comprises a plurality of vertically aligned carbon nanofibers (VACNFs), or wherein the three-dimensional current collector comprises a nanostructured porous conductive material comprised of carbon, nickel, copper, and/or steel.

19. The method of claim 17, wherein the step of applying the charging electrical current to the battery cell results in formation of a substantially uniform layer of the lithium on the anode consisting of VACNFs, wherein the substantially uniform layer of the lithium on the VACNFs comprises micro-columnar deposits of the lithium infiltrated in a porous structure of the VACNFs.

20. The method of claim 14, wherein the anode exhibits an average Coulombic Efficiency (CE) of at least 80% after 100 cycles of the applying and withdrawing steps.
